(19) United States
(12) Patent Application Publication
(10) Pub. No.: US 2002/0115435 A1
(43) Pub. Date: Aug. 22, 2002

(54) Wireless data management system

(76) Inventor: You Seung SOH, Prospect, KY (US)

Correspondence Address: WENDEROTH, LIND & PONACK, L.L.P., 2033 K STREET N. W., SUITE 800, WASHINGTON, DC, 20006-1021, US

(21) Appl. No.: 09/885,097

(22) Filed: Jun. 21, 2001

Related U.S. Application Data
(60) Provisional application No. 60/269,439, filed on Feb. 16, 2001.
(60) Provisional application No. 60/286,515, filed on Apr. 26, 2001.

(51) Int. Cl. H04Q 7/20

(52) U.S. Cl. 455/426; 455/403; 455/556

(57) ABSTRACT

The wireless data management system is a digital wireless communication system for use in the hospitality industry. The system has several components, including a host station, which is a computerized station that collects, processes and manages data and is the primary control center. The host station houses software programs for management of seating, zoning, and timing. The programs are designed for communication, control, and interaction with one or more of the components of the system, including a table transmitter, station transmitter, mobile receiver, and wireless data controller. The table transmitter is used by customers to send specific requests. The station transmitter is used by the kitchen and bar areas to notify staff of completed customer orders. The mobile receiver, which is small, mobile and wireless, is capable of receiving alpha-numeric messages from table transmitters, station transmitters, and the host station. The wireless data controller receives, amplifies, and transmits data signals.

### BACKGROUND OF THE INVENTION

1. Technical Field

The present invention relates to a wireless data management system, (“WDMS”), for the hospitality industry linking the communication, collection, recordation, and reporting of data including instantaneous feedback from remote units for the efficient control of service within the hospitality industry, such as in restaurants. The system is designed to improve and enhance internal communications, enhance the efficiency and productivity of the entire staff, provide better customer service, and provide tools for better management.

2. Description of the Prior Art

Various hard-wired or wireless communication systems have been utilized in the past for communicating a simple request for service from customer to a central location. However, none of these systems utilized digital, programmable units linked with a server(s), providing communication with the customer's table, servers, managers, the kitchen, or hostess to integrate data regarding food service, seating, and zoning from a central host station providing instantaneous communication there between, feedback there from, recordation of data, the ability to instantaneously change parameters optimizing efficient food service, and the utilization of available seating space and staff.

### SUMMARY OF THE INVENTION

The wireless data management system is a fully programmable management system designed for the hospitality industry. The WDMS increases, enhances, and manages all communication traffic between management, staff, and guests. This increased communication results in higher efficiency of the establishment. The system increases the establishment's manageability by providing a situational overview of the establishment's operations and by providing real-time and post event reporting. In addition this system maximizes customer service by providing a means for the customer to request the level of service rendered. This is accomplished by allowing customers to send a request to a server just by pressing a selected programmable request button on a device referred to herein as a table transmitter, thereby maximizing customer service.

The ability to identify strengths and weaknesses of staff will also add to create higher productivity. The system keeps the service smooth and efficient, keeps the customer satisfied, and increases table turnover. A brief overview of the system components is as follows.

As mentioned above, the system includes one or more table transmitters. The table transmitter is a programmable, wireless, easy to operate stand-alone unit that transmits signals through the wireless data controller to mobile receivers or the host station of the system. The mobile receivers and host station are discussed in more detail below. A hidden “Shift” button can be included on the table transmitter, and is primarily used for additional internal communications features and allows restaurant employees to transmit certain information while eliminating erroneous transmission of such information by customers. The table transmitter can include a transmission acknowledgement light, which provides direct feedback to the user that a request has been submitted. The table transmitter is a portable tabletop unit and preferably uses 3 AAA batteries for power.

A second form of the table transmitter, labeled “table transmitter (Type 2)”, is available without the ability for the customer to send specific requests to the mobile receiver. All other functionality, with respect to the table transmitter (type 1), remains the same.

The system also includes a wireless data controller, which is a central data processing unit that controls and amplifies signal traffic of all wireless data in the system.

The mobile receivers of the system are wireless, clip-on or wrist mounted, alphanumeric message receivers. These receivers can operate in a beep or vibrate mode when receiving a message, with a chirp reminder if messages are not acknowledged immediately. The mobile receiver preferably has a back light illumination for easier viewing of messages in dark environments. The mobile receiver preferably runs on a single AAA battery and is worn by managers, servers, food runners, and bus staff.

The system also includes station transmitters, which are units utilized by the kitchen staff or bar staff to send calls to specific mobile receivers. Kitchen and bar station transmitters are keypad type units that provide an efficient means of notifying servers or food runners that an order for a particular table is ready to be delivered. The station transmitter preferably has a phone-style numeric keypad with numbers 1 through 9 and a “0” button. The station transmitter can also include a “SEND” and “CANCEL” button to transmit or clear requests. The table number typed in is displayed on a LED screen located above the keypad.

The host station is a server based computer system that houses four main software programs, the initial program set-up, the seating management system, the zoning management programming software and the timing management software. The host station includes an input device, such as a keyboard, and a display device. In order to add to ease of use, the host station can include a color touch screen monitor, serving as the display device and part of the input device, for receiving commands from the user and for displaying information. An initial set-up screen provides a guided programming method for initially programming the software.

The wireless data management system is for use in a restaurant that includes a plurality of tables. Users of the system include restaurant employees and customers. The table transmitters are each located at a respective table in the restaurant. Each table transmitter includes an input device, such as a keypad, for receiving data input by a user. Each table transmitter receives the data input through its input device and wirelessly transmits the data. The wireless data controller wirelessly receives the data transmitted by the table transmitters and sends data received from the table transmitters to the host station and/or the mobile receivers. The information is preferably sent from the wireless data controller to the host station via a hardwired connection.

The host station receives the data from the table transmitters via the wireless data controller and displays, on the display device of the host station, a graphical representation of an area of the restaurant including a graphical representation of the tables located within the graphical representation of the area of the restaurant so as to represent the physical location of the tables in the restaurant. The host station also displays information related to the tables based at least in part on the data received from the table transmitters.

Each table transmitter can receive a “table-available” indication through its input device indicating that the respective table is available for seating customers and, after the table-available indication is received, wirelessly transmits the table-available indication. Preferably, the table-available indication is input via a keypad on the table transmitter by a member of the bussing staff after the table is cleaned. The table transmitters can be configured to include a hidden shift key which is pressed by a user, e.g., a member of the bussing staff, followed by a predetermined key or key sequence on the keypad to send the table-available indication. The wireless data controller wirelessly receives table-available indications transmitted by the table transmitters and sends the received table-available indications to the host station. The host station receives table-available indications from the wireless data controller and displays, on the display device of the host station in response to reception of a table-available indication, a visual indication that the respective table is available.

The host station can display the indication that the respective table is available by changing the color of the graphical representation of the respective table to a color that, according to a predetermined legend, indicates that the table is available. Preferably, the host station displays the indication that the respective table is available by changing the color of the graphical representation of the respective table to green.

Each table transmitter can receive a “table-occupied” indication through its input device indicating that the respective table is occupied and, after the table-occupied indication is received, wirelessly transmits the table-occupied indication. Preferably, the table-occupied indication is input via the keypad on the table transmitter by a user, e.g., the server, host or hostess, after customers are seated. The user presses the hidden shift key followed by a predetermined key or key sequence on the keypad to send the table-occupied indication. The wireless data controller wirelessly receives table-occupied indications transmitted by the table transmitters and sends the received table-occupied indications to the host station. The host station receives table-occupied indications from the wireless data controller and displays, on the display device of the host station in response to reception of each table-occupied indication, a visual indication that the respective table is occupied.

The host station can display the indication that the respective table is occupied by changing the color of the graphical representation of the respective table to a color that, according to the predetermined legend, indicates that the respective table is occupied. Preferably, the host station displays the indication that the respective table is occupied by changing the color of the graphical representation of the respective table to red.

The host station stores an average dining time, starts a counting down of a table clock for each table for which a table-occupied indication has been received, counts down from the average dining time, and indicates the counting down of one or more of the table clocks on the display device of the host station. The host station can display one or more of the table clocks such that each of the table clocks is displayed in association with a corresponding table. For example, the host station can gradually change the appearance of the graphical representation of a table in accordance with the counting down of the table clock corresponding to the table so as to indicate the counting down of the table clock corresponding to the table. The gradual change in appearance can be a gradual changing of the color of the graphical representation of the table in accordance with the counting down of the clock. The gradual changing of the color of the graphical representation of a table can be done by gradually changing the color from the top of the graphical representation of the table to the bottom of the graphical representation of the table.

Each table transmitter can also receive a “needs-cleaning” indication through its input device and, after the needs-cleaning indication is received, wirelessly transmits the needs-cleaning indication. The needs-cleaning indication indicates that the respective table needs cleaning. Preferably, the needs-cleaning indication is input via the keypad on the table transmitter by a user, e.g., the server, after customers are finished and have left the table. The user presses the hidden shift key followed by a predetermined key or key sequence on the keypad to send the needs-cleaning indication. The wireless data controller wirelessly receives needs-cleaning indications transmitted by the table transmitters and sends the needs-cleaning indications to the host station. The host station receives the needs-cleaning indications from the wireless data controller and displays, on the display device of the host station in response to reception of each needs-cleaning indication, a visual indication that the respective table needs cleaning.

The host station can display the visual indication that the respective table needs cleaning by changing the color of the graphical representation of the respective table to a color that, according to the predetermined legend, indicates that the respective table needs cleaning. Preferably, the host station displays the indication that the respective table needs cleaning by changing the color of the graphical representation of the respective table to yellow.

The host station stores statistical information related to the table, and displays the statistical information in response to a request for display of the statistical information input by a user, e.g., the manager, host or hostess, through the input device of the host station. The statistical information can include various information about the table, such as table number, seating capacity, smoking preference, and duration of current seating status (available, occupied, needs cleaning).

The host station preferably includes a touch-screen monitor which serves as the input device and the display device. Also, the host station includes a keyboard which serves as part of the input device. The touch screen enables input of commands from a user via the graphical representation of the restaurant including the tables and through buttons displayed on the monitor. For example, the touch-screen monitor detects a touching by the user of the graphical representation of the table as the request for display of the statistical information. The keyboard serves as the input device for alpha-numeric data that cannot be input via the touch screen.

The mobile receivers of the system are each used by a server-person assigned to one or more of the tables, a buss person or manager. The wireless data controller stores transmitter/receiver association data indicating which of the table transmitters is associated with each of the mobile receivers, i.e., which mobile receiver receives data from which table transmitters. The wireless data controller wirelessly transmits data received from the table transmitters to the mobile receivers in accordance with the transmitter/receiver association data. Thus, information transmitted from a table transmitter is sent by the wireless data controller to the correct mobile receiver by reference to the transmitter/receiver association data. Also, the wireless data controller wirelessly transmits data received from the host station to the mobile receivers, such as text messages from the manager to a server or servers.

When the wireless data controller wirelessly receives table-occupied indications transmitted by the table transmitters, it wirelessly transmits the received table-occupied indications such that the wirelessly transmitted table-occupied indications are addressed to the mobile receivers in accordance with the transmitter/receiver association data. The mobile receivers wirelessly receive a table-occupied indication transmitted by the wireless data controller and provide to the server, in response to reception of the table-occupied indication, an indication that the respective table is occupied.

As mentioned above, the system also includes at least one station transmitter, to be located at a respective preparation area, e.g., a kitchen or bar. Each station transmitter includes an input device operable to receive data input by a user, e.g., a cook or bar tender, and each station transmitter receives the data input through its input device and wirelessly transmits the data. The wireless data controller wirelessly receives the data transmitted by the station transmitter and sends data received from the station transmitter to the mobile receiver, which receives the data.

Specifically, the station transmitter receives an “order-ready” indication through its input device. The order-ready indication indicates that an order made to the respective preparation area is ready. The station transmitter then wirelessly transmits the order-ready indication. The wireless data controller wirelessly receives the order-ready indication transmitted by the station transmitter and wirelessly transmits the order-ready indication such that the wirelessly transmitted order-ready indication is addressed to the appropriate mobile receiver, i.e., the mobile receiver of the server who placed the order. The mobile receiver wirelessly receives the order-ready indication transmitted by the wireless data controller and provides to the server, in response to reception of the order-ready indication, an indication that the order is ready.

The host station stores a pre-programmed set of server configurations. Each server configuration provides an assignment of tables to servers such that the tables are divided among a number of servers. The server configurations also provide a corresponding transmitter/receiver association data indicating which of the table transmitters is associated with each of the mobile receivers according to the assignment of tables to servers of the respective server configuration. The host station applies one of the server configurations in accordance with a configuration choice input by a user through the input device of the host station. Each of the server configurations provides an assignment of some or all of the plurality of tables among a different number of servers, such that a change in the server configuration by the user changes the number of servers among which assignment of the tables is divided.

The host station displays a plurality of server-number buttons, each indicating a different number of servers. For example, “1SVR” (one server), to “50SVR” (fifty servers). The host station stores button/configuration correspondence data, which indicates a correspondence between each server-number button and a respective server configuration. The server-number buttons indicate the number of servers among which the assignment of tables is divided in the server configuration corresponding to the server-number buttons, respectively. Thus, for example, the “5SVR” button indicates that the server configuration corresponding to the “5SVR” button provides that the assignment of the tables is divided among five servers. The host station receives the configuration choice by detecting a user's touch of one of the server-number buttons on the touch-screen monitor, and applies the server configuration corresponding to the server-number button touched by the user according to the stored button/configuration correspondence data.

The host station also includes a “one-time” function. The host station sets in the wireless data controller a one-time temporary transmitter/receiver association between one or more of the table transmitters and one of the mobile receivers, wherein the one-time temporary transmitter/receiver association lasts through one seating cycle of the table or tables corresponding to the one or more table transmitters included in the one-time association, or through the end of a current seating cycle of the table or tables corresponding to the one or more table transmitters included in the one-time association. The one time function is accomplished in response to the user pressing a “one-time” button on the touch-screen monitor as well as other buttons indicating the desired table or tables and the desired mobile receiver to be temporarily assigned.

The features of the system can be carried out on a computer according to a software program embodied on any computer readable medium. The software program can be written according to any one of many known programming techniques.

In operation, the software program instructs the computer (serving as the host station) to display, on a display device of the computer, a graphical representation of an area of a restaurant including a graphical representation of tables located within the graphical representation of the area of the restaurant so as to represent the physical location of the tables in the restaurant as well as information related to the tables based at least in part on data received from the table transmitters.

The software program instructs the computer to receive the table-available indications and to display a visual indication that the respective table is available, such as by changing the color of the graphical representation of the respective table to a color that, according to a predetermined legend, indicates that the table is available, e.g., to the color green.

The software program instructs the computer to receive the table occupied indications and to display a visual indication that the respective table is occupied, such as by changing the color of the graphical representation of the respective table to a color that, according to the predetermined legend, indicates that the respective table is occupied, e.g., to the color red.

The software program instructs the computer to store the average dining time, start a counting down of the table clocks to count down from the average dining time, and to indicate the counting down of one or more of the table clocks. The table clocks can be displayed such that each of the table clocks is displayed in association with a corresponding table. The software program can instruct the computer to gradually change the appearance of the graphical representation of a table in accordance with the counting down of the table clock corresponding to the table so as to indicate the counting down of the table clock corresponding to the table, for example, by gradually changing the color of the graphical representation of the table in accordance with the counting down of the clock. This color change can be done by gradually changing the color from the top of the graphical representation of the table to the bottom of the graphical representation of the table.

The software program also instructs the computer to receive the needs-cleaning indications and to display a visual indication that the respective table needs cleaning, for example, by changing the color of the graphical representation of the respective table to a color that, according to the predetermined legend, indicates that the respective table needs cleaning, e.g., to the color yellow.

The software program also instruct the computer to store the statistical information related to the table, and to display the statistical information in response to a request for display of the statistical information input into the computer by a user.

The software program can also instruct the computer to send information to one or more mobile receivers to be used by server-persons assigned to the tables, one or more buss persons, or one or more managers.

The software program also instructs the computer to receive the order-ready indication which indicates that an order made to a preparation area is ready. The software program also instructs the computer to store the pre-programmed set of server configurations, which can be predetermined or set by a user. Each server configuration provides an assignment of tables to servers such that the tables are divided among a number of servers and providing a corresponding transmitter/receiver association data indicating which of a plurality of the table transmitters is associated with each of a plurality of mobile receivers according to the assignment of table to servers of the respective server configuration, and to apply one of the server configurations in accordance with a configuration choice input to the computer by a user. Each of the server configurations of the pre-programmed set of server configurations provides an assignment of some or all of the plurality of tables among a different number of servers, such that a change in the server configuration by the user changes the number of servers among which assignment of the tables is divided.

The software program instructs the computer to display a plurality of server-number buttons, each indicating a different number of servers, store button/configuration correspondence data indicating a correspondence between each server-number button and a respective server configuration, wherein the server-number buttons indicate the number of servers among which the assignment of tables is divided in the server configuration corresponding to the server-number buttons, respectively, receive the configuration choice by detecting a user's touch of one of the server-number buttons, and apply the server configuration corresponding to the server-number button touched by the user according to the stored button/configuration correspondence data.

The software program can also instruct the computer to set the one-time temporary transmitter/receiver association between one or more of the table transmitters and one of the mobile receivers, wherein the one-time temporary transmitter/receiver association lasts through one seating cycle of the table or tables corresponding to the one or more table transmitters included in the one-time association, or through the end of a current seating cycle of the table or tables corresponding to the one or more table transmitters included in the one-time association.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a data flow schematic of a wireless data controller, mobile receiver, station transmitter, host station, and table transmitter of the present invention showing the sending and receiving relationship there between by arrows;

FIG. 2 is an orthographic view showing a wireless, digital table transmitter including six programmable buttons;

FIG. 3 is a three-view drawing showing a wireless, digital table transmitter including exemplary dimensions;

FIG. 4 is an orthographic view showing a wireless, digital table transmitter (type 2) including four programmable buttons that are used for internal communications only;

FIG. 5 is a four-view drawing showing a wireless data controller including the receiver, processor, and amplifier that receives data from the table transmitters and/or station transmitters and sends it to the corresponding mobile receiver;

FIG. 6 is a four-view drawing of a station transmitter according to the present invention;

FIG. 7 is a three-view drawing showing a wireless, alphanumeric mobile receiver and its dimensions for the present invention which includes a clip-on or wrist mounted holder, a beep and/or vibrate mode, a chirp reminder, a back light illumination, and is powered by a battery, which are not shown in present drawing;

FIG. 8 is a WDMS combined system flow chart showing an option of the wireless data controller and station transmitter;

FIG. 9 is a flow chart showing an operation of a wireless data controller, table transmitter, station transmitter, and mobile receiver in accordance with the present invention;

FIG. 10 is a flow chart showing an operation of a table transmitter of the present invention;

FIG. 11 is a schematic of a wireless data controller according to the present invention;

FIG. 12 is a schematic of the RF part of a wireless data controller of the present invention;

FIG. 13 is a schematic of the RX logic part of a wireless data controller of the present invention;

FIG. 14 is an exemplary circuit diagram of a transmission part of a wireless data controller of the present invention;

FIG. 15 is schematic of a table transmitter according to the present invention;

FIG. 16 is an exemplary circuit diagram of a mobile receiver according to the present invention;

FIG. 17 is an exemplary circuit diagram of a mobile receiver according to the present invention;

FIG. 18 is another schematic of a mobile receiver according to the present invention;

FIG. 19 is a schematic of a station transmitter according to the present invention;

FIG. 20 shows a WELCOME screen on the host station with feature selections;

FIG. 21 shows an initial setup screen pallet on the host station;

FIG. 22 shows a seating management program screen view on the host station;

FIG. 23 shows a zoning management program screen view on the host station;

FIG. 24 shows a timing management program screen view on the host station;

FIG. 25 shows an alpha message program screen view as part of the seating management software on the host station;

FIG. 26 is a flow chart showing an alpha message diagram;

FIG. 27 is a flow chart showing a customer service request diagram;

FIG. 28 is a flow chart showing an “available seating notification” diagram;

FIG. 29 is a flow chart showing an “occupied seating notification” diagram;

FIG. 30 is a flow chart showing a “preparation request notification” diagram;

FIG. 31 is a flow chart showing a “manager call” diagram;

FIG. 32 is a flow chart showing a “ready food notification” diagram;

FIG. 33 is a flow chart showing a station transmitter call-bar diagram.

FIG. 34 is an exemplary circuit diagram of a wireless data controller circuit of the present invention.

FIG. 35 is an exemplary circuit diagram of a power part of a wireless data controller of the present invention.

FIG. 36 is an exemplary circuit diagram of an RF part of a wireless data controller of the present invention.

FIG. 37 is an exemplary circuit diagram of a receiving part of a wireless data controller of the present invention.

FIG. 38 is an exemplary circuit diagram of a table transmitter of the present invention.

FIG. 39 is an exemplary circuit diagram of a station transmitter of the present invention.

FIG. 40 is another exemplary circuit diagram of a station transmitter of the present invention.

### DETAILED DESCRIPTION OF THE PREFERRED EMBODIMENTS

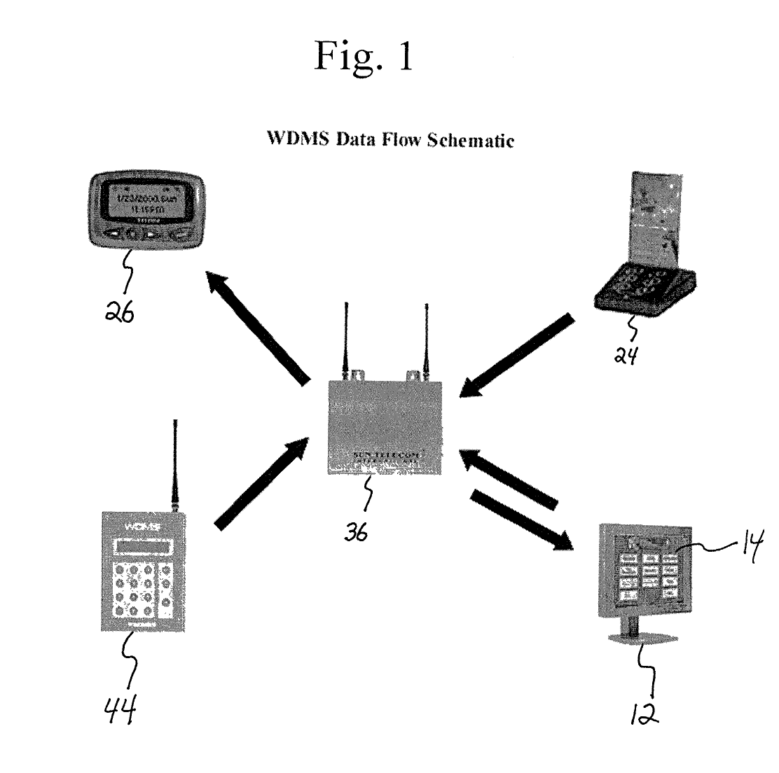

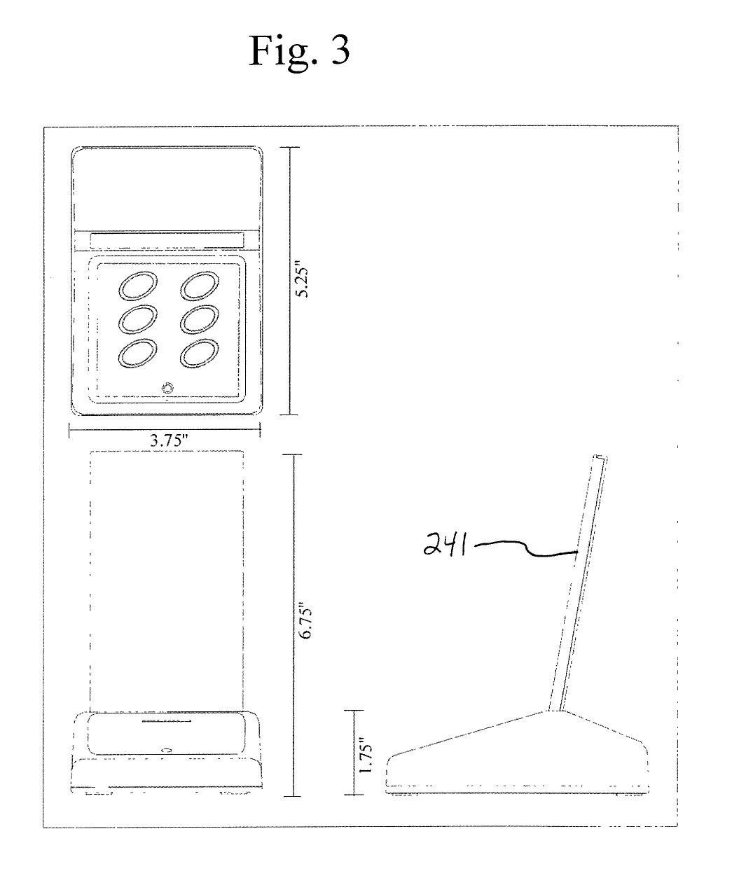

With reference FIGS. 1-33, the details and mode of operation of preferred embodiments of the wireless data management system (WDMS) and its components are described as follows:

The WDMS is easy to install, maintain, and program. The WDMS is shown in FIG. 1 and includes a wireless data controller 36, a host station 12, one or more table transmitters 24, one or more station transmitters 44, and one or more mobile receivers 26. The system is constructed in a modular format capable of being used as a whole or with selected components, suiting an individual establishment's needs. The system utilizes a UHF band to wirelessly transmit and receive data to and from various units, with an approximate broadcasting area of 5,000 to 10,000 square feet.

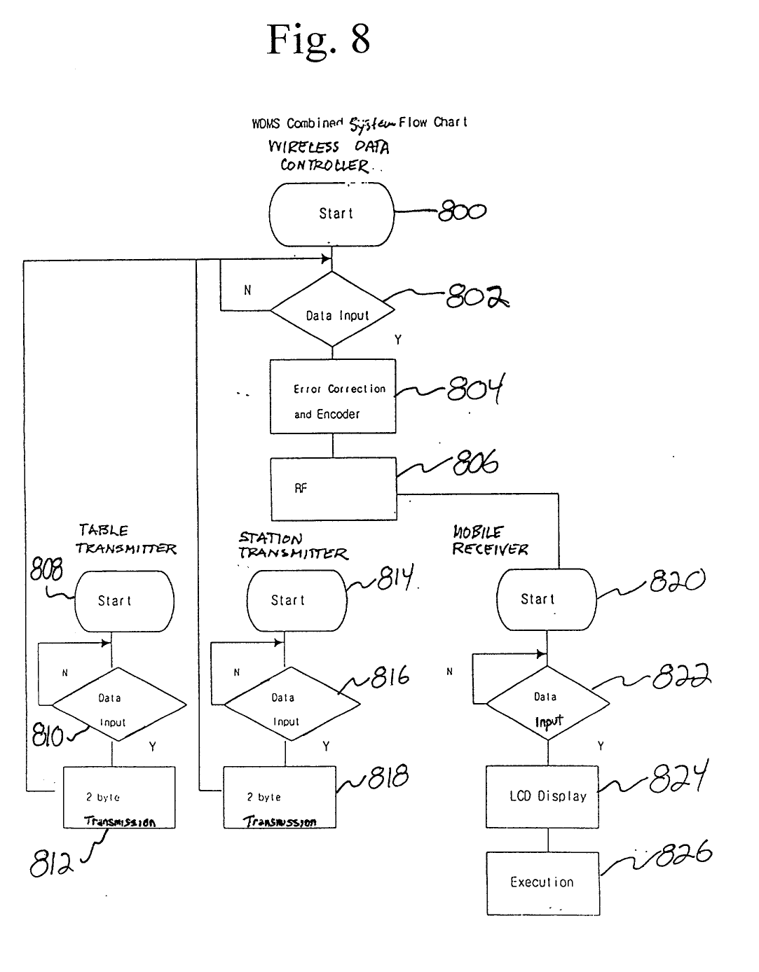

The wireless data controller 36 preferably measures 9.25″×2.25″×7.25″ (L×W×H). It controls and amplifies signal traffic of all wireless data and is capable of exchanging data with up to 200 table transmitters 24. As illustrated in FIG. 1, the wireless data controller 36 is the receiving/processing/transmitting unit that receives messages from the host station 12, table transmitters 24, and station transmitters 44, and then transmits the information to a specific mobile receiver 26 in accordance with addressing information associated with the message. The wireless data controller 36 can support up to fifty mobile receivers 26. AC current powers the wireless data controller 36. It transmits up to 10,000 square feet depending on location, interference, etc. A schematic diagram is shown in FIGS. 8-9, and 11-14.

A flow chart of the operation of the system is illustrated in FIG. 8, which shows the operation of the table transmitter 24, station transmitter 44, wireless data controller 36, and the mobile receiver 26, and the communication among these components of the system. Information from the table transmitter 24 is input by a customer, server, or bussing staff person at the table at which the table transmitter 24 is located. Examples of such information are a “ready to order” indication by the customer, a notification by the server to the bussing staff to clean a vacated table, and an indication by the bussing staff person that the table has been cleared. The various types of information, and the method of inputting such information into the table transmitter 24 by a user, are discussed in more detail below.

In the table transmitter 24, operation begins at step 808 and proceeds to step 810, where the table transmitter 24 determines whether data is input by a user into the table transmitter 24. If the determination at step 810 is no, then the step 810 is repeated, thereby checking again whether data has been inputted. When the determination at step 810 is affirmative that data has been input into the table transmitter 24, then operation flows to step 812. At step 812, the table transmitter 24 wirelessly transmits the inputted data via a known method of radio frequency (RF) transmission. Preferably, the information is transmitted as 2 bytes of digital data.

Information from the station transmitter 44 is input by a cook or bar tender in the kitchen or bar at which the station transmitter 44 is located. An example of such information is an “order is ready for pick-up” indication by the cook or bar tender. The various types of information, and the method of inputting such information into the station transmitter 44 by a user, are discussed in more detail below.

In the station transmitter 44, operation begins at step 814 and proceeds to step 816, where the station transmitter 44 determines whether data is input by a user into the station transmitter 24. If the determination at step 816 is no, then the step 816 is repeated, thereby checking again whether data has been inputted. When the determination at step 816 is affirmative that data has been input into the station transmitter 44, then operation flows to step 818. At step 818, the station transmitter 44 wirelessly transmits the inputted data via a known method of radio frequency (RF) transmission. Preferably, the information is transmitted as 2 bytes of digital data.

Step 800 is the start point of the processing operation of the wireless data controller 36, which operates to receive data that has been transmitted by the table transmitters 24 and the station transmitters 36, as well as by the host station 12. After the processing is started at step 800, operation flows to step 802 where the wireless data controller 36 determines if data is being input to the wireless data controller 36, e.g., if data is received from a table transmitter 24 and/or station transmitter 44. Data is received by the wireless data controller according to a known method of receiving radio frequency (RF) signals. If the determination at step 802 is no, then the step 802 is repeated, thereby checking again whether data has been inputted. When the determination at step 802 is affirmative that data is being input into the wireless data controller 36, then operation flows to step 804. At step 804, the wireless data controller 36 performs error correction using a known error correction method. Also in step 804, the wireless data controller encodes the data, which was input and error corrected, into a suitable format for wireless transmission. Then, in step 806, the wireless data controller 36 transmits the encoded data via a known method of radio frequency (RF) transmission.

Steps 820-826 illustrate the reception and processing by the mobile receiver 26 from the wireless data controller 36. The data that is received by the mobile receiver 26 can originate from a station transmitter 44, a table transmitter 24, or the host station 12. Processing begins in the mobile receiver 26 in step 820 and proceeds to step 822, which is a data loop to verify if the data being received is correct data. If it is correct, processing proceeds to step 824 in which the data is sent to the LCD (display) of the mobile receiver 26 to be viewed. Next, in step 826, after viewing, some type of execution is required such as, deleting the message or simply acknowledging it and turning off the alarm by the user.

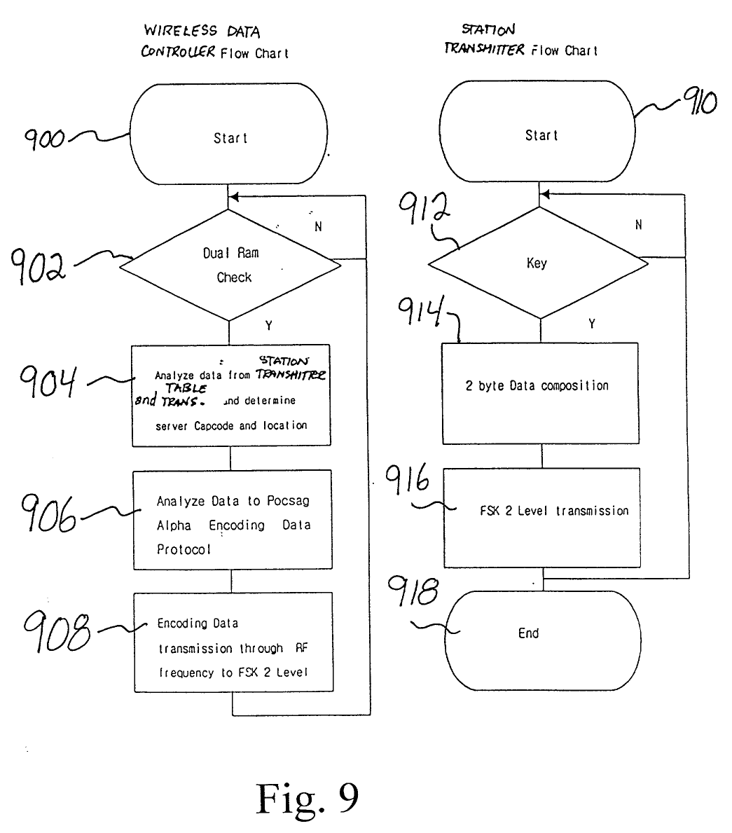

Flow charts of operations of the wireless data controller 36 and the station transmitter 44 are illustrated in FIG. 9. On the wireless data controller 36 side of FIG. 9 processing begins at step 900 and proceeds to step 902, where a dual RAM (memory) check is performed by the wireless data controller 36. If the memory checks out OK, the wireless data controller proceeds to step 904 to analyze data received from either the station transmitter 44 or the table transmitter 24 to determine the addressing information, i.e., the CapCode and location, of the data that has just been received by the wireless data controller 36. After the addressing of the sent information is determined, the wireless data controller 36 proceeds to step 906 and converts the received data into Pocsag Alpha Encoded data so that it can be received by the mobile receiver 26. Finally, in step 908, the wireless data controller 36 transmits the information via RF frequency to FSX 2 level (a standard protocol for sending) so that it can be received by the mobile receiver 26.

On the station transmitter side of FIG. 9, processing begins at step 910 and proceeds to step 912 where the keying in of information is awaited and detected by the station transmitter 44. If the station transmitter 44 information determines in step 912 that the inputted data is valid, the station transmitter 44 converts the data to a 2 byte data composition in step 914. In step 916, the station transmitter 44 then transmits the data via FSX 2 level transmission to the wireless data controller 36 which in turn sends it to the mobile receiver 26 via the above process. After transmission, the processing of the station transmitter ends at step 918.

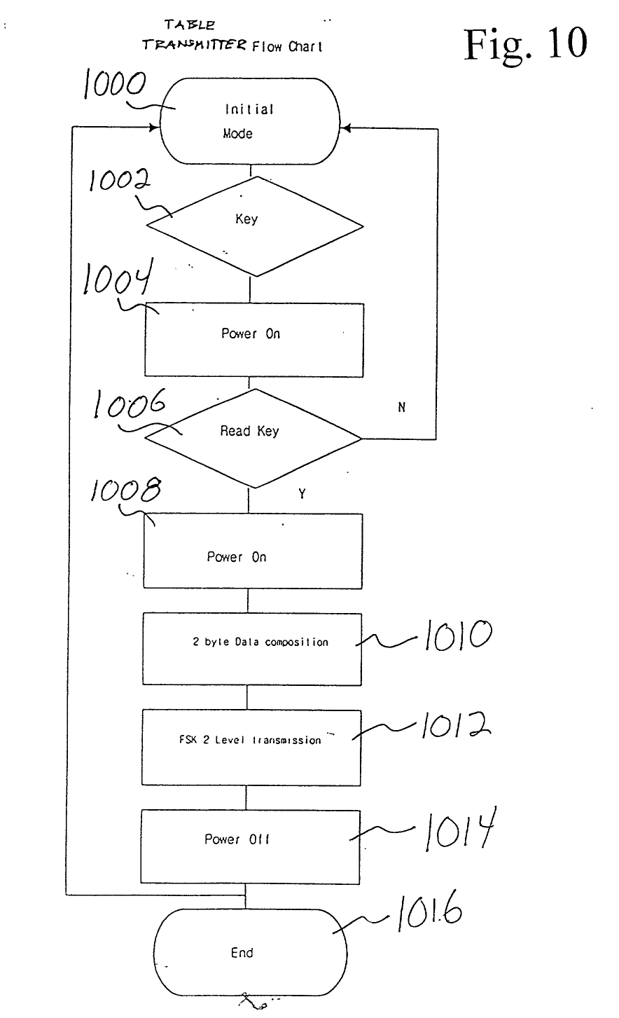

FIG. 10 illustrates a flow chart of an operation of the table transmitter 24. When the table transmitter 24 is activated, the following sequence is observed. The initial mode of operation, step 1000, is a “sleep” mode. By a user depressing any key the table transmitter 24 is powered on in steps 1002 and 1004. After the power is on, the table transmitter 24 proceeds, in step 1006 to read the key that was just pressed. After verifying that a key was pressed in step 1008, the table transmitter 24 converts the data to 2 byte data composition, in step 1010 for transmission to the wireless data controller 26. The transmission is sent via FSX 2 level transmission protocol in step 1012. At which point the table transmitter 24 powers itself off in step 1014 to conserve battery life. Processing ends in step 1016.

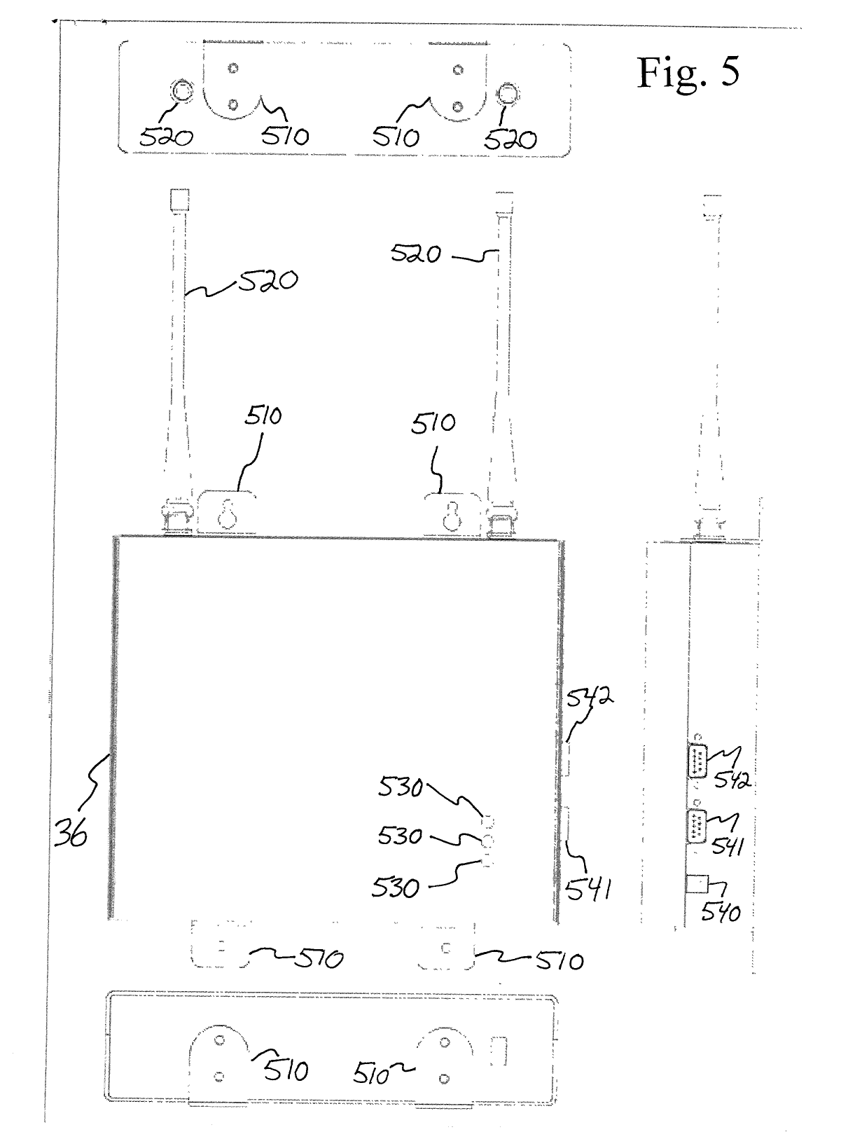

The wireless data controller 36 is illustrated in FIG. 5. The wireless data controller 36 is preferably powered by a nine volt, 1.5-ampere transformer equipped with a barrel connector. The transformer is plugged into any standard 110-volt wall receptacle. It operates at 450 to 470 MHz+-p.m., at 1200 bps, and 25 KHz. The unit can be attached to a wall by placing screws into four angle brackets 510 on the top and bottom of the device, and attaching the screws to a wall. There are two antennas 520, preferably seven-inch antennas, for the purpose of reception and rebroadcast of a signal in the UHF bandwidth. On the bottom right side of the front panel are three indicator lights 530, which may be amber lights each one-quarter of an inch in diameter. The top light is labeled signal out, and registers any activity in the unit. The other two lights indicate that the device is on and the power supply is functioning normally and are labeled 5 V power and 9 V power, respectively. On the right side of the device is a power input node 540, fitted for a barrel connector. Above it is a serial port 541, so other electronic devices can be merged for the purpose of data collection or assimilation into other systems. The top most plug is a serial port 542 labeled EEPROM. The function of this port is to program the system.

The wireless data controller 36 also utilizes synthesized technology, where all units can be programmed in different frequencies within the UHF band, decreasing the possibility of conflict and/or interference with other wireless systems.

All of the addressing information for wireless transmissions in the system is contained within the wireless data controller 36, preferably in the EEPROM chip. The table transmitters 24 are identified by a table transmitter number, which can be the same as the table number for example. The table transmitter number is assigned at the initial set up, and is then transferred upon “program” to the wireless data controller 36. Also at initial set up for zoning, the mobile receivers 26 are identified to the wireless data controller 36 as well. The mobile receiver 26 is identified through a Capcode. The Capcode is a 7 or 9 digit number that identifies a specific mobile receiver 26 to the wireless data controller 36 much like an IP address identifies a specific computer to a network. When a signal is sent from a table transmitter 24 or station transmitter 44, the signal goes to the wireless data controller 36. Upon receipt of the signal by the wireless data controller 36, the wireless data controller 36 then determines via addressing which mobile receiver 26 the signal needs to be sent to. For example, a request is made for service via a specific table transmitter 24. That signal is sent to the wireless data controller 36 where the wireless data controller 36 determines the proper mobile receiver the signal needs to go to based on the Capcode that is assigned to that mobile receiver 26 that is covering the specific table. The wireless data controller 36 then sends the signal to the correct mobile receiver 26 (or Capcode) along with the specific request.

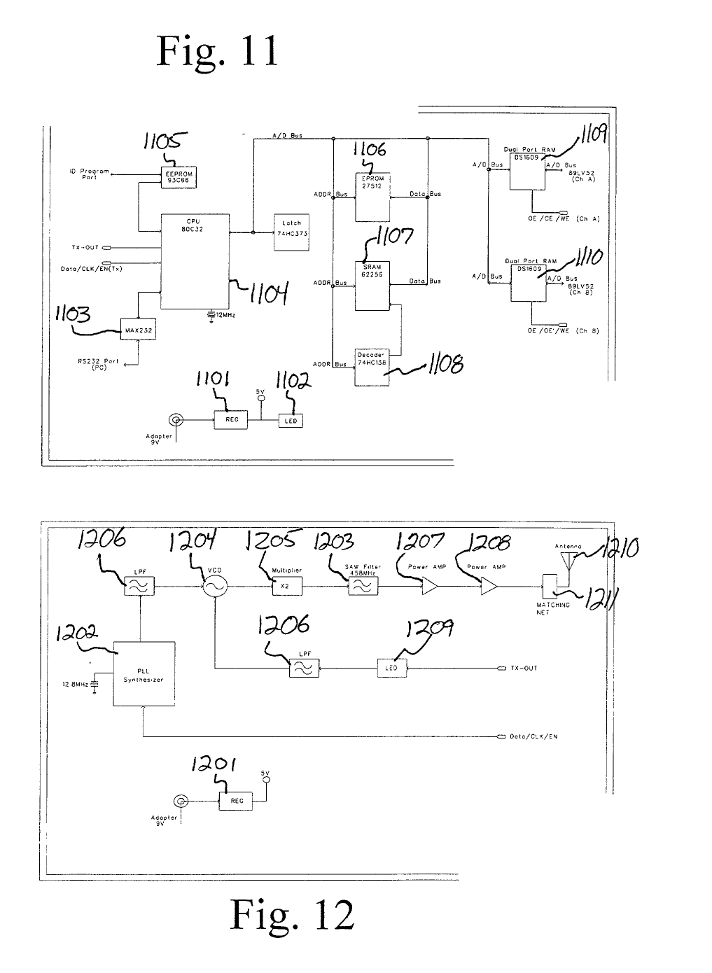

FIG. 11 is a block diagram of the wireless data controller 36. The regulator 1101 regulates a continuous 3 Volt power supply received from the batteries. The LED 1102 operates to confirm execution of input. The Max232 element 1103 converts the information from the CPU 1104 into a useable export format. The CPU 1104 controls functionality of the wireless data controller 36. The EEPROM 1106 stores programmed information not limited to but including unit ID and operating frequency of the table transmitters, station transmitters and mobile receivers. EEPROM port 1105 is a 15 pin serial port that allows computer access to the EEPROM 1106 for programming purposes. The SRAM 1107 stores software depending on the request from the CPU 1104. Or it will store information based on the CPU request. The decoder 1108 decodes the received signal and applies it to the CPU 1104. The RAM 1109 stores information depending on the request from the CPU. Or it will store information based on the CPU request. RAM 1110 stores information depending on the request from the CPU 1104. Or it will store information based on the CPU request.

FIG. 12 is a block diagram of the transmission portion of the wireless data controller 36 according to a preferred embodiment. The regulator 1201 regulates a continuous 3 Volt power supply received from the batteries. The PLL Synthesizer 1202 generates a channel frequency. This is an IC that synthesizes the transmission channel frequency. The saw filter 1203 filters out unnecessary signals and transmits the useful signal. The VCO (Voltage Control Oscillator) 1204 provides for a change in frequency by changing the voltage. The multiplier 1205 produces the real carrier frequency. The loop filters 1206 eliminate noise on the signal. The power amp 1207 increases the multiplier signal. The power amp 1208 also increases the multiplier signal. The LED 1209 confirms execution of input. The antenna 1210 transmits signals as output of the wireless data controller 36. The matching network component 1211 matches the resistance (Ohms) on both sides of it. The resistance on the antenna side of this component may differ from that of the other side of this component. So that there is no variation and that the signal goes out smoothly the matching network syncs the resistance on both sides.

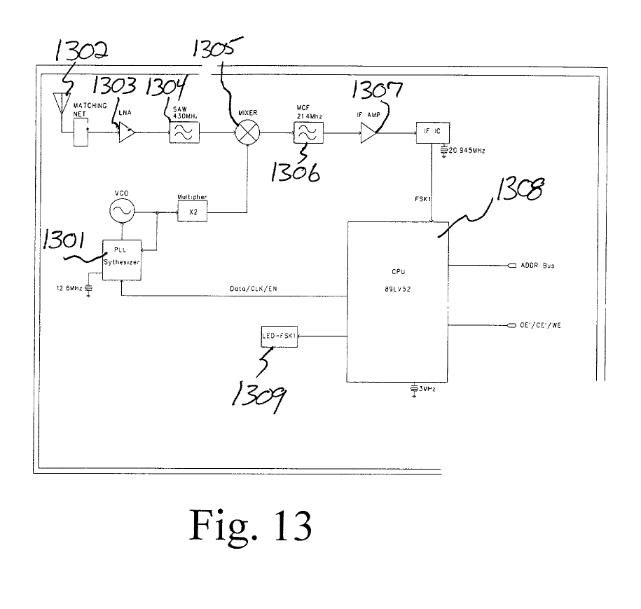

FIG. 13 is a block diagram of the receiver portion of the wireless data controller 36 according to a preferred embodiment. The PLL synthesizer 1301 generates a channel frequency. This is an IC that synthesizes the transmission channel frequency. The antenna 1302 wirelessly receives signals. The power amp 1303 increases the multiplier signal. The saw filter 1304 filters out unnecessary signals and transmits the useful signal. The mixer 1305 combines power with input of signal. The saw filter 1306 filters out unnecessary signals and transmits the useful signal. The multiplier 1307 produces the real carrier frequency. The CPU 1308 controls the functionality of the wireless data controller 36. The LED 1309 confirms execution of input.

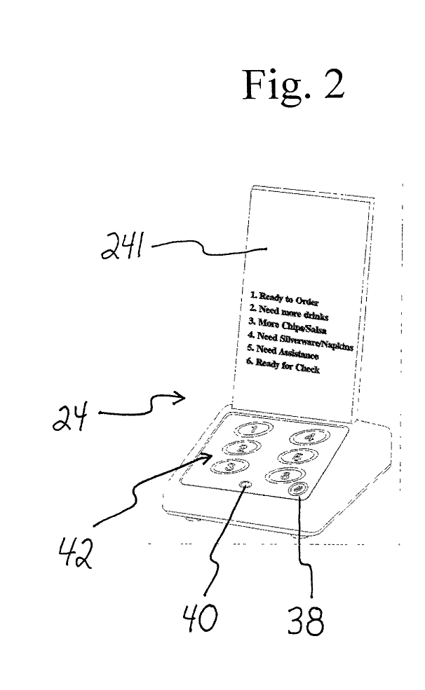

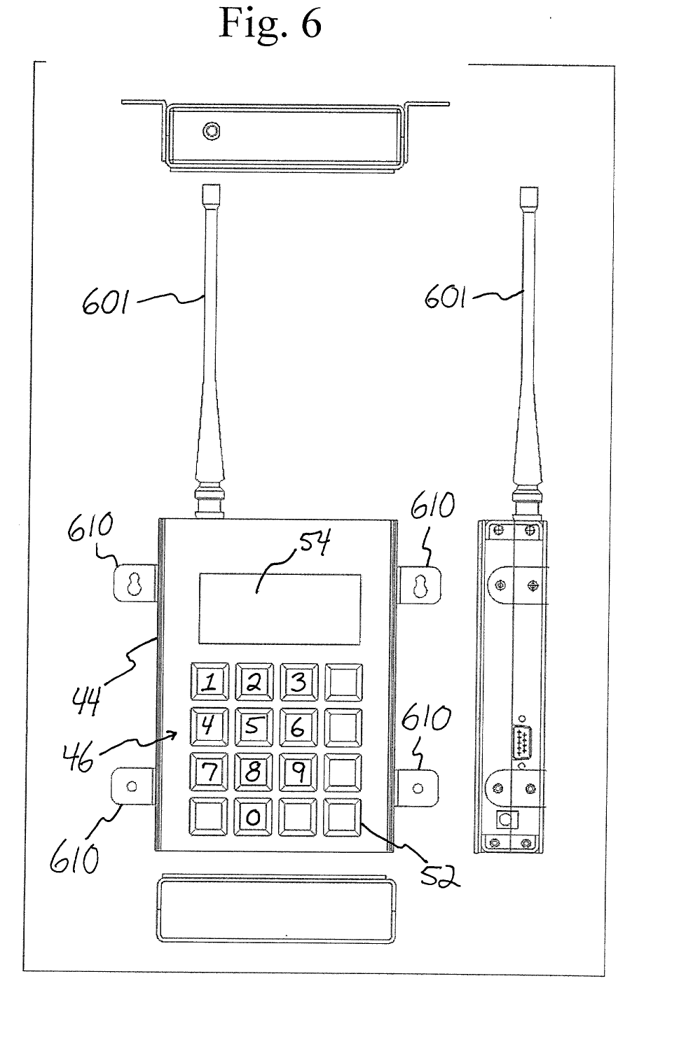

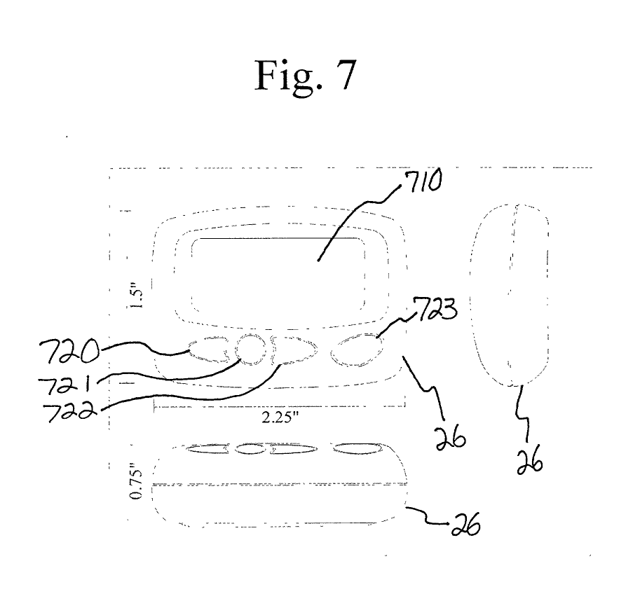

The wireless data controller 36 shown in FIG. 5 acts to receive, validate and relay signals from the other parts of the system. When the unit receives a wireless transmission from the table transmitter 24, as illustrated in FIG. 2, station transmitter 44, as illustrated in FIG. 6, or the host station 12, it sends the information to the appropriate mobile receiver shown in FIG. 7, and the wait staff acts on the given signal to attend a table, pick up an order or go to the management upon request. The wireless data controller 36 also regulates signals from the table transmitter 24 to the host station 12 making the staff aware of changes in table status in the dining area.

The host station 12 includes a server based computer system that houses software programs, including, for example, an initial program set-up, seating management software, zoning management software, and timing management software. The host station 12 adds to the ease of use by preferably including a color touch screen monitor 14.

An initial set-up screen of the host station 12 provides a guided programming method for initially programming the software packages as shown in FIG. 21.

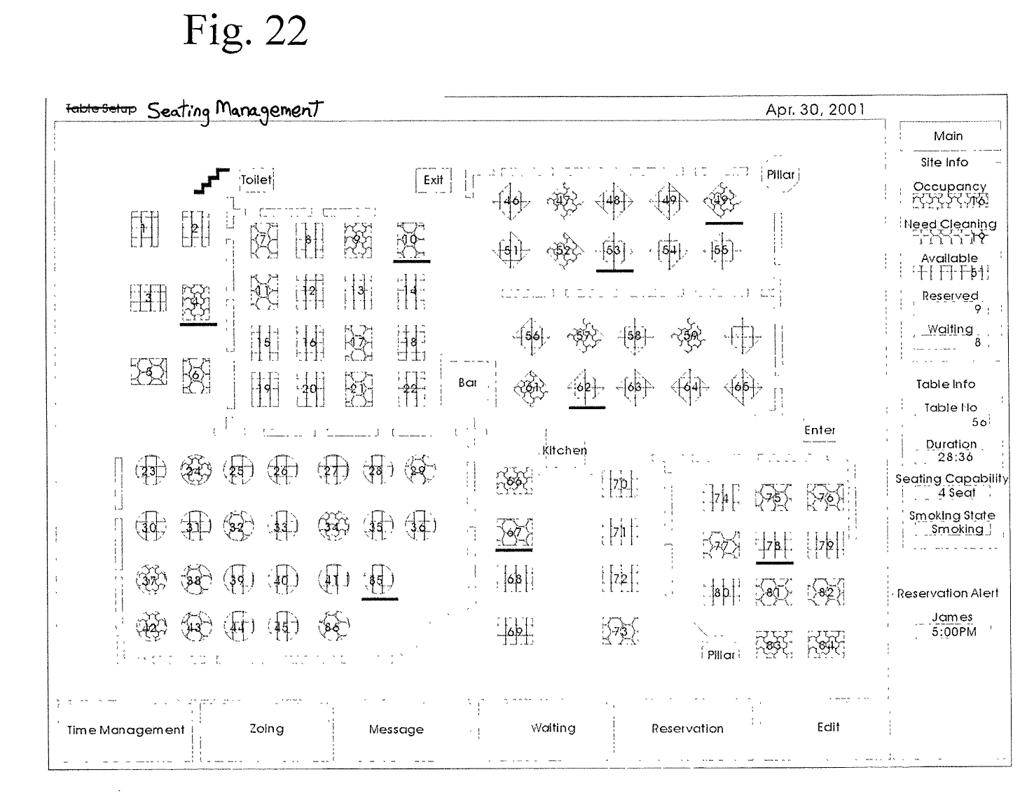

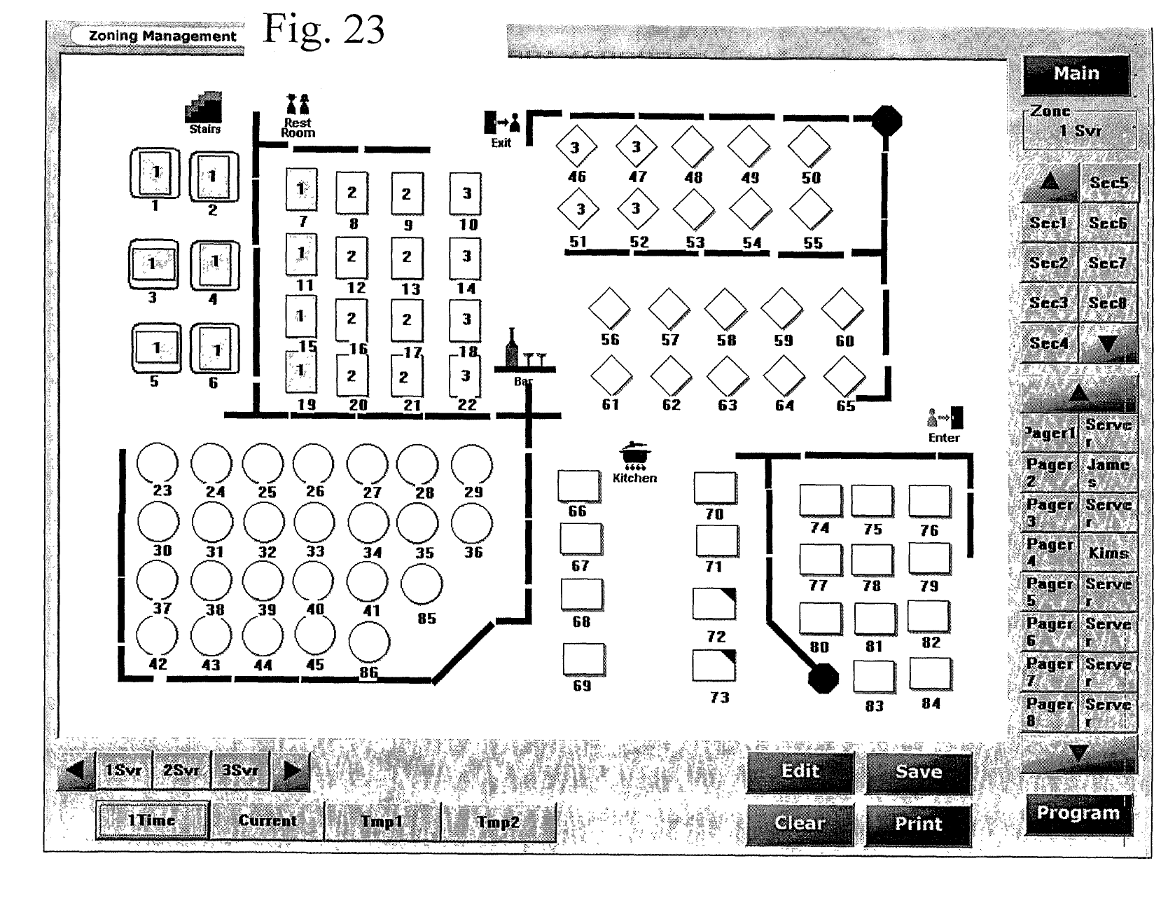

The seating management program provides real-time status of table usage based on communication with the table transmitters 24 to show the availability of each table on the monitor 14 of the host station 12 as shown on the seating management screen in FIG. 22. The host station 12 displays a graphical representation of the restaurant interior, including tables, bars, restrooms, kitchen, etc. The host station 12 indicates the status of the tables by changing the displayed representation of the tables according to a predetermined legend. For example, the color of the tables represented on the monitor can be changed to indicate the status of the table. Tables displayed in GREEN (shown with square hatching in FIG. 22) are visually identified as an “Un-occupied” or “Available” table. Tables displayed in RED (shown with angular hatching in FIG. 22) are visually identified as an “Occupied” table. Finally tables displayed as YELLOW (shown with circular hatching in FIG. 22) are visually identified as “Needs Cleaning” in preparation for reseating.

Along with the visual display of the seating status of any given table in the dining room, each table's individual statistics can be obtained simply by clicking on that table on the touch screen monitor 14 from the seating management screen, shown in FIG. 22. The information displayed for an individual table can include the table number, seating capacity, smoking preference, and the duration of the current status (available, occupied, needs-cleaning) of the table. For example, if the table is listed as “occupied” then the duration time showing how long the table has been “occupied” is displayed.

The zoning management program of the host station 12 allows the restaurant to change the server coverage configuration quickly with the press of a button on the touch screen monitor 14. The user interface with the zoning management program is the zoning management screen, shown in FIG. 23. Each server configuration provides an assignment of tables to servers such that the tables are divided among a number of servers. The server configurations also provide a corresponding transmitter/receiver association data indicating which of the table transmitters is associated with each of the mobile receivers according to the assignment of tables to servers of the respective server configuration. The host station 12 applies one of the server configurations in accordance with a configuration choice input by a user through the input device 14 of the host station 12. Each of the server configurations provides an assignment of some or all of the plurality of tables among a different number of servers, such that a change in the server configuration by the user changes the number of servers among which assignment of the tables is divided.

When the manager needs additional servers to work the dining room due to increased customer traffic, they can be added to the current configuration. The manager has a pre-programmed set of server configurations that are input at initial set-up. This pre-programmed set of server configurations can be modified on a temporary or permanent basis. Across the bottom of the screen are buttons designated “1 Svr” through “50 Svr”. These buttons allow the manager to select the number of servers working the dining room by selecting the appropriate number of servers button. For example, if the manager currently has 2 servers working and needs to add two more. The manager will simply select the “4 Svr”, button then select the “Program” button. This will reconfigure the table transmitter 24 to message the appropriate mobile receiver 26. However, these changes will not take effect on those tables already occupied until the table transmitters 24 have cycled through the seating management stages for dining such as “occupied”, “needs cleaning” and “ready for seating”.

The host station 12 stores button/configuration correspondence data, which indicates a correspondence between each server-number button and a respective server configuration. The server-number buttons indicate the number of servers among which the assignment of tables is divided in the server configuration corresponding to the server-number buttons, respectively. Thus, for example, the “5SVR” button indicates that the server configuration corresponding to the “5SVR” button provides that the assignment of the tables is divided among five servers, The host station 12 receives the configuration choice by detecting a user's touch of one of the server-number buttons on the touch-screen monitor 14, and applies the server configuration corresponding to the server-number button touched by the user according to the stored button/configuration correspondence data.

The independent reprogramming capability by the system is referred to as “smart programming”. “Smart programming” is the ability of the system to reprogram table transmitters 24 to message the appropriate mobile receivers 26 after the table transmitter 24 has cycled through the seating management stages. Through the use of this “smart programming”, changes can be made to server's coverage configuration without disturbing customers already sitting at tables.

The zoning management program also has the ability to change which table transmitter 24 messages a mobile receiver or receivers 26 on a one-time basis. The user selects a table from the zoning management screen (FIG. 23) to be changed to a different server and the server or mobile receiver 26 to which the table is to be changed. The user selects the “1 TIME” button then selects the “Program” button. This change will only be in effect until the current party occupying the table has finished and the table transmitter 24 has cycled through the seating management program. After the party leaves, and the table has cycled, the table transmitter 24 will revert back to messaging the original server that the permanent programming selected.

The zoning management program also offers a “temporary edit” capability that will not affect permanent programming. This temporary editing capability allows the programmer to make changes to a server's coverage area. Once the changes are made, the programmer can select the “program” button. By selecting the “program” button, and not selecting the “Save” button and one of the “SVR” buttons, the changes made will take effect only until programming is changed again. This allows for changes to be made on a temporary basis, not affecting the programming on a permanent basis.

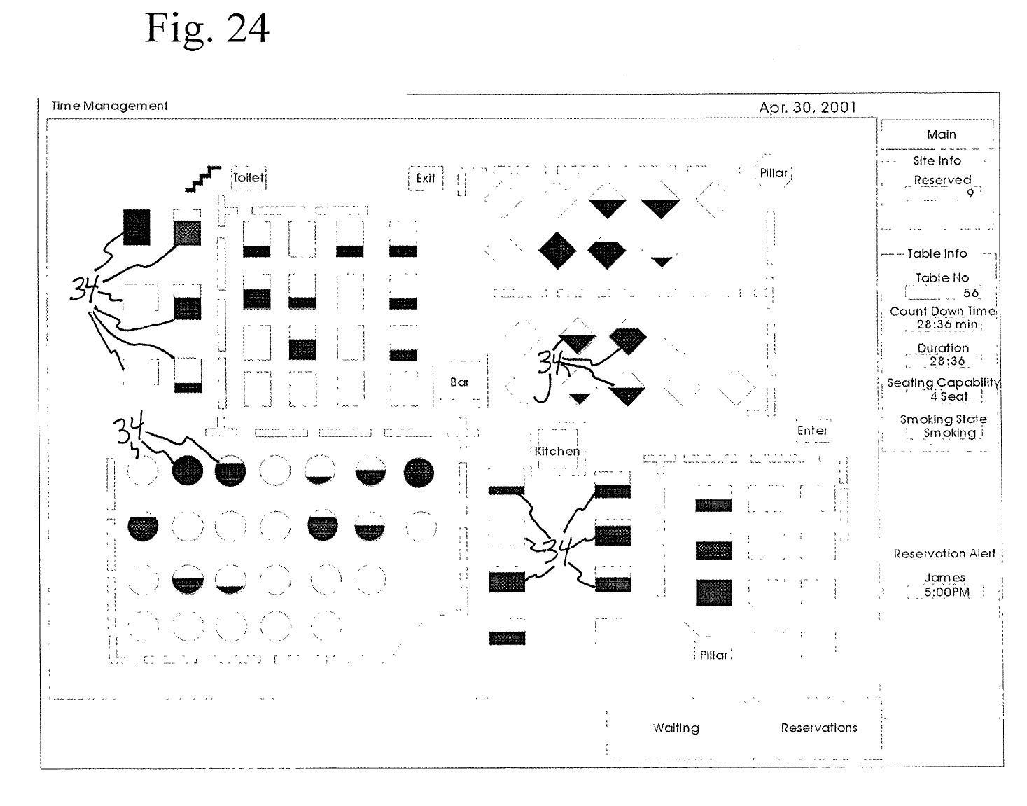

The timing management program is a program that offers the management or hostess access to timing statistics of individual tables as well as table overview, as shown in the time management screen of FIG. 24. The time management screen is displayed on the touch screen monitor 14 of the host station 12 and allows the manager or hostess to more accurately gauge the timing of table availability in a scientific manor rather than using the traditional “educated guess”. This general overview of table usage also allows the management or hostess an easy alternative to eliminate wasted time roaming the restaurant looking for the next available seating. The timing management program starts a clock the instant a guest is seated. This clock is started once the seating management program is notified that the table is “Occupied.” When the table becomes occupied, the clock, which counts down from a predetermined average dining time, will accurately time the portion of the guests dining experience from the time the table is occupied to the time the table is vacated. A graphic version of the clock is displayed on the time management screen in the form of a table icon 34, for each table. This icon 34 will change color from top to bottom much like an hourglass, to indicate the countdown of time starting from the preprogrammed average dining time. With this information, over time, an accurate average to the second can be obtained for the guests average dining time. By selecting any one of the table icons 34, detailed information will be displayed about that table in the “table info” portion of the time management screen. Information contained in the table info portion will let the hostess or manager know the table specific data including the duration of current table seating status.

When a guest is seated, the host station 12 begins a counting down of the countdown timer for that table and displays the counting down on the time management screen. For example, if the average dining time of a restaurant is 45 minutes per table, the countdown timer will start at 45 minutes when a guest is seated. A visual display starting at 45 minutes (based on the earlier hypothetical) and counting down backwards from that time will indicate how much time is left for that guest. The time management program will then be able to display the countdown timers of all occupied tables. This function of the time management screen allows the hostess or manager to have a comprehensive overview of the status of all tables in the restaurant and which are due to be finished soon. This provides the manager or hostess a more accurate way to gauge the next available table that meets the next waiting guest's seating criteria, i.e., number of guests, seating preference and smoking preference.

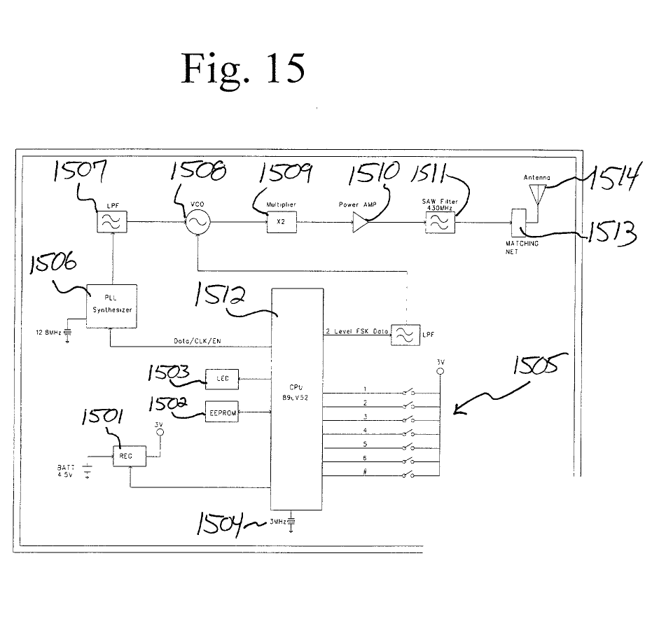

The table transmitter 24 as shown in FIG. 2, is a programmable, wireless, easy to operate, stand-alone unit that transmits signals through the wireless data controller 36 to mobile receivers 26 or the host station 12. A hidden “Shift” button 38, known only to the staff, also on the table transmitter 24, is primarily used for additional internal communication features. The table transmitter 24 has a transmission acknowledgement light 40, which provides direct feedback to the user that a request has been submitted via a multi-item menu of six programmable buttons 42. Of course, it is contemplated that any number of buttons can be incorporated therewith depending upon the use thereof, including number and/or letter and/or design indicia. Moreover, a dial or other means of interfacing can be utilized with the table transmitter 24. The table transmitter 24 of the preferred embodiment is a portable tabletop unit that uses 3 AAA batteries for power. The table transmitter 24 is constructed of a durable polymer material that offers a water resistant and easy to clean design. A schematic diagram of the table transmitter 24 is shown in FIG. 15.

FIG. 15 is a block diagram of a table transmitter 24 according to a preferred embodiment. The regulator 1501 regulates a continuous 3 Volt power supply received from the batteries that power the table transmitter 24. The EEPROM 1502 stores programmed information not limited to but including the operating frequency and Unit ID of the table transmitter 24. The LED 1503 confirms execution of input by providing a lighted indication to the user. As shown by reference numeral 1504, the CPU 1512 is enabled to operate at a 3 Mhz clock speed. The buttons 1505 are programmed key pad buttons for allowing the input of various commands by the users. The PLL Synthesizer 1506 generates a channel frequency. This is an IC that synthesizes the transmission channel frequency. The loop filter 1507 eliminates noise on the signal. The VCO (Voltage Control Oscillator) 1508 provides for a change in frequency by changing the voltage. The multiplier 1509 produces the real carrier frequency. The power amp 1510 increases the multiplier signal. The saw filter 1511 filters out unnecessary signal and transmits the useful signal. The CPU 1512 controls functionality of the table transmitter 24. The antenna 1514 transmits signals as output of the table transmitter 24. The matching network component 1513 matches the resistance (Ohms) on both sides of it. The resistance on the antenna side of this component may differ from that of the other side of this component. So that there is no variation and that the signal goes out smoothly the matching network syncs the resistance on both sides.

The table transmitter 24 preferably measures 5.25″×3.75″×1.5″ (L×W×H) and has a clear plastic backing panel 241 that stands an additional five inches high. This panel is primarily used to display the programmed functions of the buttons, as well as the establishment's logo or any other advertisements. In the preferred embodiment, there are six buttons 42 on the angled face of the table transmitter 24 in two rows of three that are numbered one through six. These buttons correspond with pre-programmed text managements that are labeled on the backing panel. These managements for example may read “Ready to Order”, “Need More Drinks”, “Need Silverware”, “Ready for Check”, “Need more Bread”, and “General Help”. These programmable text messages can be changed in the programming of the unit. For Example, “Need More Bread” can be changed to “Need More Chips and Salsa”. The text of the six request buttons of the table transmitter 24 is programmed through the wireless data controller EEPROM and/or through the initial set-up software. At the bottom of the button panel lies an indicator light, for example an amber LED one-sixteenth inch in diameter, built into the angled face of the table transmitter 24. Each button is a raised oval disk of plastic one inch wide and a half-inch long. On the base of the table transmitter 24, there are four black rubber anti-skid legs to keep the unit secure to the table. The backing panel can also include an electronic display device for displaying the functions of the buttons. Alternatively, the buttons and display can be embodied by a touch screen display.

The table transmitter 24 has a ‘sleep’ mode to conserve energy. Depressing any of the buttons deactivates the sleep ‘mode’. When a button is depressed, a green LED is activated to show that a function is operating. Depressing a request for a pre-programmed time interval sends the data, activating a green LED, indicating that the transaction was successful. This tamper-proof feature prevents children from sending requests by simply touching a button. To prevent abuse of the table transmitter 24 by the customer, a function called “request block” can be activated at the host station 12. This function allows the manager to block requests to the server's mobile receiver 26 for a duration of one to fifteen minutes, blocking annoying and abusive requests by customers.

In the lower right corner of the face plate of the table transmitter 24 is a hidden switch, which can be activated by a staff member. When the table has been vacated and needs to be cleaned, the server utilizes the hidden switch in combination with a specific key sequence to simultaneously notify the bussing staff to clean the table, and to transmit a signal to the host station 12, updating the table status to change the representation of the table icon to indicate that the table “Needs Cleaning”, e.g., by changing the color of the table icon to yellow, on the seating management screen (FIG. 22). When the table is available and clean, the bussing staff utilizes the hidden switch, in combination with a specific key or key sequence, which transmits a signal to the host station 12, updating the table status to “Available”, e.g., by changing the color of the table icon to green on the seating management screen, which indicates that the table is ready for seating. When customers are seated, the hostess employs the hidden switch in combination with a specific key or key sequence to simultaneously notify a specific server to attend the guest, and to transmit a signal to the host station 12, updating the table status to “Occupied”, e.g., by changing the color of the table icon to red on the seating management screen, which indicates that the table is occupied. Another function of the hidden switch is to summon the manager on duty. The server initiates this function by pressing the hidden switch and a key or key sequence when their table requires special assistance.

The table transmitter's button function text is programmed through an EEPROM port 542 on the wireless data controller 36. The wireless data controller 36 has a synthesized capability that allows for the unit to change frequencies within the UHF band, and is thus not limited to a fixed frequency within the UHF band. The EEPROM port 542 is a serial connection that allows for the wireless data controller 36 and all other units to be programmed via computer.

Identification settings of the table transmitter 24 are programmed through the initial setup software on the host station 12 to allow for the table transmitter 24 to be easily re-assigned to another server group should reassignment of tables be necessary. The table transmitter 24 operates at a frequency of from 450 to 470 MHZ with a frequency stability of +−5 ppm. The preferred data rate is 4800 bps. The channel space is 25 kHz. The modulation is FSK 2 level with an output power of 10 mW. A low battery display is included indicated by a light and the preferred power supply is a battery.

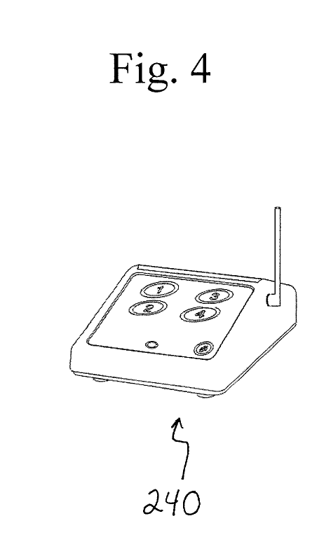

The table transmitter (type 2) 240, as shown in FIG. 4, has the same dimensions as the aforementioned table transmitter 24, with the exception that the 5″ backing panel 241 is omitted. The table transmitter (type 2) 240 has four programmable buttons on its face primarily used for internal communications only. This unit is used in establishments where the management wants no interaction between the guest and the server. The type 2 table transmitter 240 works in conjunction with the host station 12 in a similar manner to the aforementioned table transmitter 24 in order to maintain the functionality of the seating management, and timing management software packages. Data collection, with respect to table statistics, is also available with this unit.

The station transmitter 44, as shown in FIG. 6, preferably measures 5″×8″×1.5″ (L×W×H). Primarily utilized in the kitchen and bar areas, it is a keypad type unit that provides an efficient means of notifying servers or food runners, wirelessly, that an order for a particular table is ready to be delivered. The station transmitter 44 utilizes a synthesized capability which allows for the unit's frequency to be easily reprogrammed, which reduces the incident of conflict with other wireless units. This unit has a phone-style numeric keypad 46 including buttons with numbers 1 through 9 and a “0” button. This unit also employs a “Send” and “Cancel” button 52 to transmit or clear requests. The table number is displayed on a LED screen 54 located above the keypad 46.

The station transmitter 44 is preferably powered by nine volt, 500 milliampere, barrel-plug connector equipped transformer that can be plugged into any 110 V standard receptacle. The station transmitter 44 operates at a frequency of from 450 to 470 MHz with a frequency stability of +−5 p.m. The preferred data rate is 4800 bps. The channel space is 25 KHz. The modulation is FSK 2 level with an output power of 10 mW.

There is a single antenna 601 preferably a black, seven-inch antenna, for the broadcast of signals to the wireless data controller at a frequency in the UHF band. This station transmitter 44 can also be mounted to a wall or counter top via four optional angle brackets 610.

When the kitchen has prepared an order, the cook presses the buttons on the station transmitter 44 corresponding with a table number, and pushes the SEND button 52 to notify the specific server that their order has been prepared. A signal is sent to the wireless data controller 36, which then relays the signal to the specified mobile receiver 26 corresponding to the table number entered on the station transmitter 44 by the cook. The server reads the signal on the mobile receiver 26 and picks up the food.

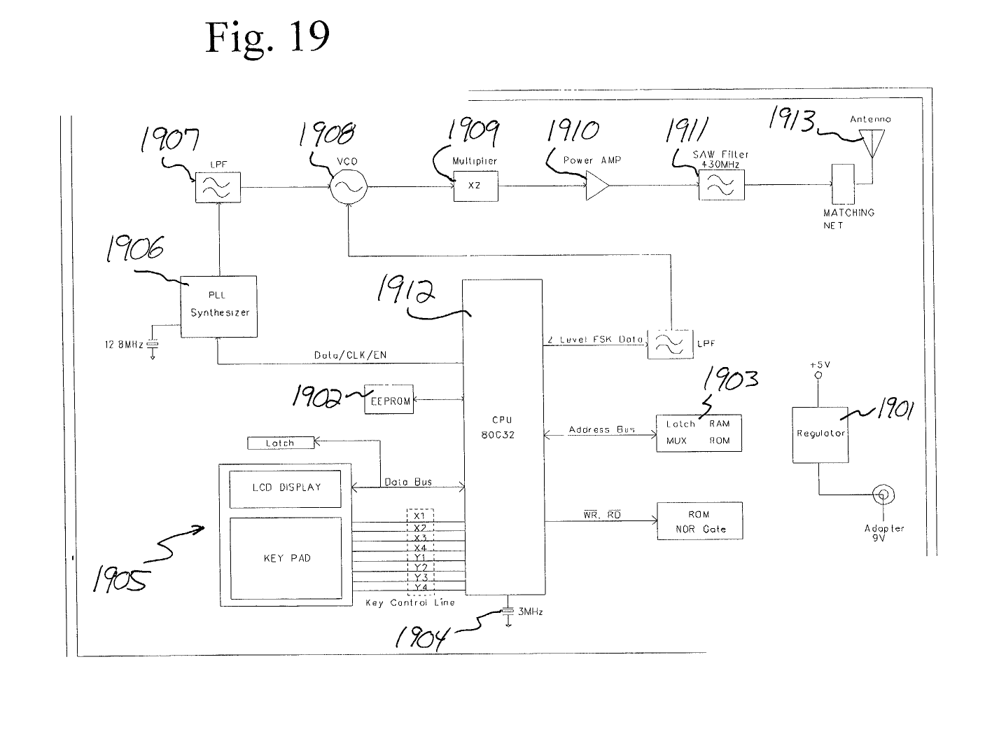

FIG. 19 is a block diagram of a station transmitter 44 according to a preferred embodiment. The regulator 1901 regulates a continuous 3 Volt power supply received from the batteries that power the station transmitter 44. The EEPROM 1902 stores programmed information not limited to but including unit operating frequency and Unit ID of the station transmitter 44. The RAM/ROM 1903 stores software depending on the request from the CPU 1912. It will or store information based on the CPU 1912 request. As shown by reference numeral 1904, the CPU 1912 is enabled to operate at a 3 Mhz clock speed. The buttons 1905 are programmed key pad buttons for allowing the input of the various commands by the users. The PLL Synthesizer 1906 generates a channel frequency. This is an IC that synthesizes the transmission channel frequency. The loop filter 1907 eliminates noise on the signal. The VCO (Voltage Control Oscillator) 1908 provides for a change in frequency by changing the voltage. The multiplier 1909 produces the real carrier frequency. The power amp 1910 increases the multiplier signal. The saw filter 1911 filters out unnecessary signal and transmits the useful signal. The CPU 1912 controls the functionality of the sable transmitter. The antenna 1913 transmits the signals output by the station transmitter 44.

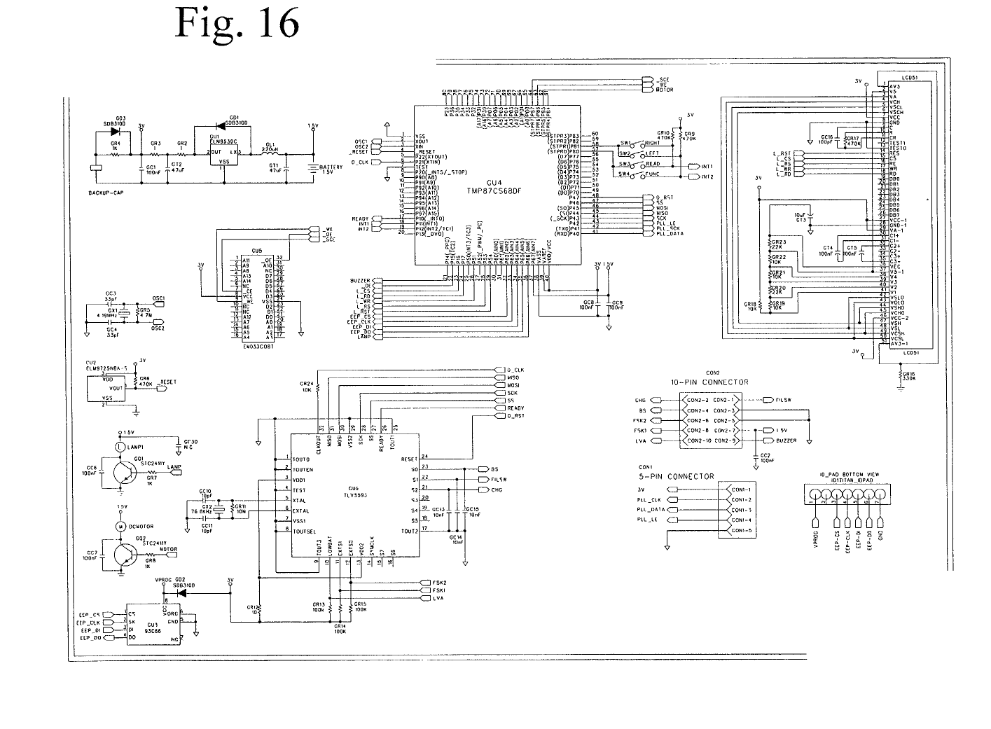

The mobile receiver 26, as shown in FIG. 7, preferably measures 2.5″×0.75″×1.75″ (L×W×H). The mobile receivers 26 are wireless, clip-on or wrist mounted, alphanumeric message receivers. These receivers can operate in a beep or vibrate mode when receiving a message, with a chirp reminder if messages are not acknowledged immediately. The mobile receiver 26 has a display 710 with back light illumination for easier viewing of messages in dark environments. This unit runs on a single AAA battery and can be worn, for example, by management, servers, food runners and bus staff. The mobile receiver 26 receives signal data from the host station 12, the station transmitter 44 and the table transmitters 24 through the wireless data controller 36. Schematic diagrams of the mobile receiver 26 are shown in FIGS. 16-18.

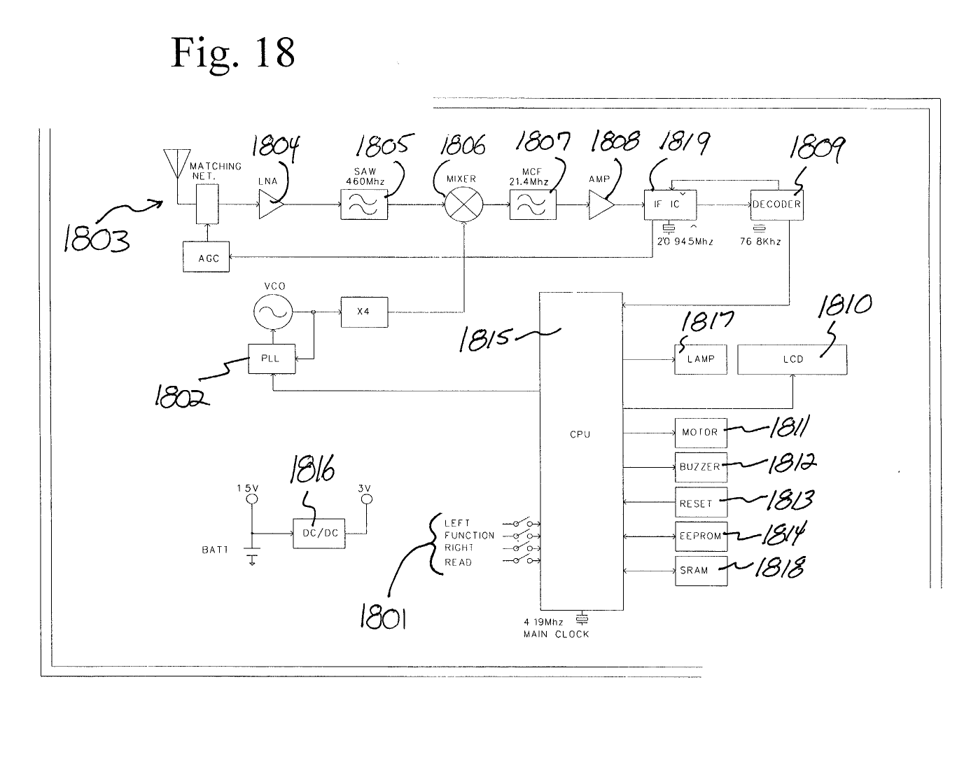

FIG. 18 is a block diagram of a mobile receiver 26 according to a preferred embodiment. The buttons 1801 are function buttons on the face of mobile receiver 26. The PLL synthesizer 1802 generates a channel frequency. This is an IC that synthesizes the transmission channel frequency. The antenna 1803 operates to transmit and receive signals. The power amp 1804 increases the multiplier signal. The saw filter 1805 filters out unnecessary signals and transmits the useful signal. The mixer 1806 combines power with input of signal. The saw filter 1807 filters out unnecessary signals and transmits the useful signal. The power amp 1808 increases the multiplier signal. The IF IC 1819 is an inter-frequency chip that extracts data from a frequency stream and sends it to the decoder 1809 to determine its validity. The decoder 1809 decodes a received signal and applies it to the CPU 1815. The LCD 1810 serves as a display for data. The motor 1811 operates to provide a notification that a message has been received by the mobile receiver 26. The motor causes the mobile receiver 26 to vibrate when a message is received. The buzzer 1812 also operates to provide a notification that a message has been received by sounding an audible tone when a message is received. The reset 1813 is an input into the CPU 1815 that institutes a reset function. The EEPROM 1814 stores programmed information not limited to but including unit operating frequency and Unit ID of the mobile receiver 26. The CPU 1815 controls the functionality of the mobile receiver 26. Reference numeral 1816 is a DC power supply of the mobile receiver 26. The lamp 1817 is a small lamp for backlight illumination. It lights up the screen in dark environments. The mobile receiver 26 includes an SRAM 1818, which is an onboard memory to store information such as stored messages.

The mobile receiver 26 comes with an optional elastic, wrist watch style strap that the server can be used to wear the unit or it can be fitted into an optional holster that can be clipped to waist belt or clothing. It is powered by one battery, and is available in various colors including black, red, blue and silver. The mobile receivers 26 receive signals from the wireless data controller 36. The mobile receiver 26 operates in the UHF band. The mobile receiver 26 has four buttons, one in a group of three on the left side and a lone button on the far right on the bottom of the front face. The left most button 720 scrolls backwards through messages or various function options and is marked with a white arrow pointing to the left, the middle button 721 is to cease the alert signal and to read the current message. This button is marked with a large red dot. The right most button 722 scrolls forward through messages or options, and has a white arrow pointing to the right. The single button to the right of the group of three is the function button 723, and is marked with a horizontal green bar. The information display 710 is preferably a liquid crystal display that is text display capable and is lit by a small bulb inside the pager for ease in reading in a dimly lit environment.

When a message is relayed to the mobile receiver 26, an alert goes off. This alert function can either be a beep or a silent vibration. The server can then check the mobile receiver 26 for a message. If for some reason, the mobile receiver's message is not accessed immediately, it will begin to chirp to remind the server that there are waiting messages. This feature can be turned on or off at will. When a message is read, the waiter/waitress has the option whether to delete the single message, or can delete an entire block of messages, if they have been answered. With the optional wrist mount, the mobile receiver 26 can be accessed easily, without having to fumble through aprons, pockets or risk upsetting a tray of food. The mobile receiver 26 also comes equipped with an “Out of Service” notification. This alert will cause the mobile receiver 26 to chirp when the unit is removed from the wireless coverage area, thus preventing the units from being taken home accidentally by the staff.

A seating management system screen view, providing a real-time status of the occupancy of a table based on information from the table transmitters 24, shows the availability of each table. Colors, letters, numbers, or other indicia are used to visually identify an unoccupied table, an occupied table, and tables that need cleaning in preparation for reseating.

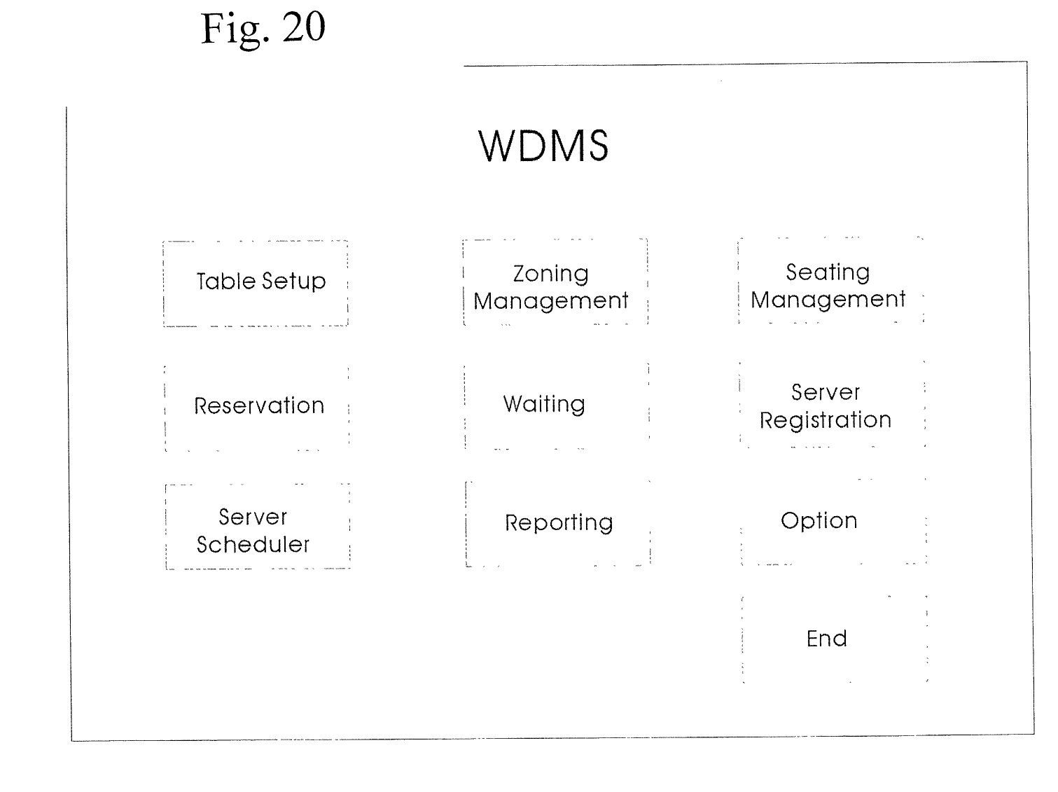

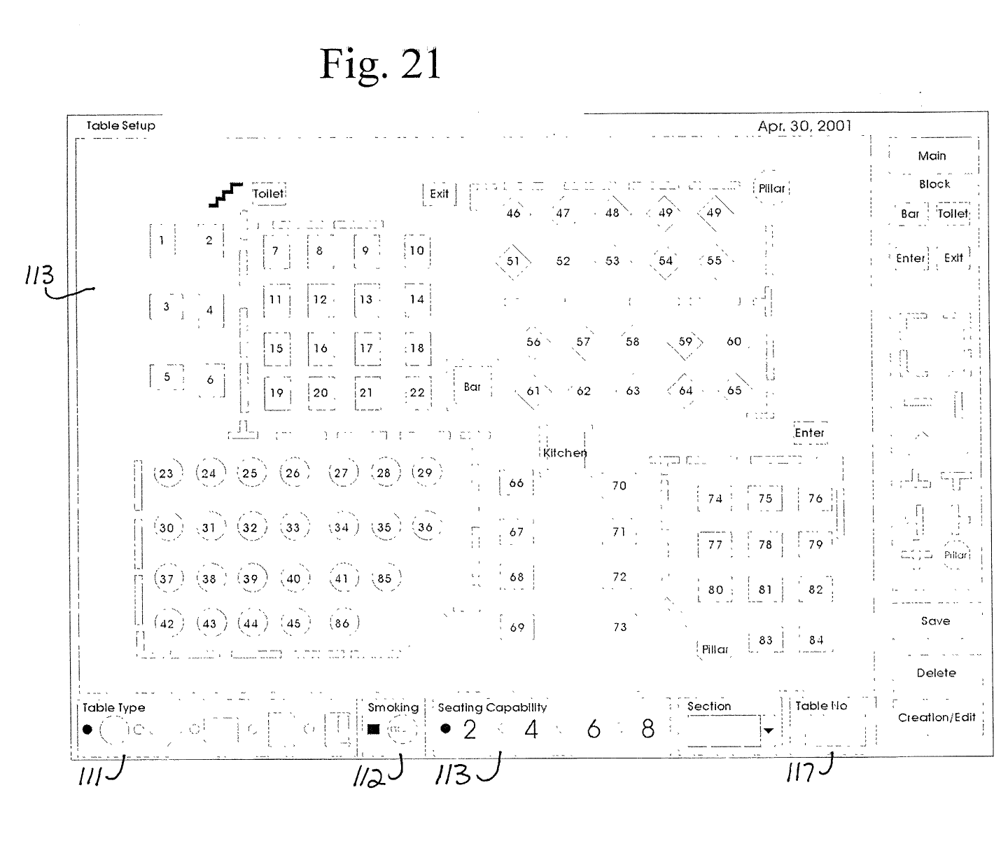

The initial set-up program and welcome screen as best illustrated in FIG. 20, allows a programmer or the establishment to custom program the seating management program and serve as a welcome screen at the beginning of daily operations. On this screen the user has several options, four of which serve as primary options: 1) options set-up; 2) table set-up; 3) zoning management; and 4) seating management. The table set-up feature provides a drag-and-drop functionality to make set-up easy. When the table set-up programming mode is selected, the program displays a table set-up screen on the touch screen monitor 14 of the host station 12. The table set-up screen is initially a blank restaurant pallet as shown in FIG. 21. The programmer can set-up the screen view pallet to resemble the restaurants layout for easy table identification.

The table set-up screen is used to set the layout for the seating management program. The programmer first chooses a table type from the table type section 111 on the bottom of the set-up screen. To place the table in its proper location, the programmer simply clicks on the pallet 113 at the location where the table is to be located. After the table is properly located, the host station 12 prompts the programmer to enter the table number in the table no. section 117 of the table set-up screen. The entry is done using the keyboard provided with the host station 12. When the table is numbered, the host station 12 prompts the programmer to enter the smoking preference for that table also in the smoking preference section 112 of the table set-up screen. This entry is done by selecting the smoking option check box in the smoking preference section 112. After the smoking preference is entered, the host station 12 prompts the programmer to enter the seating capacity for that table in the seating capacity section 113 of the table set-up screen. This entry is done by choosing one of the seating capacity check box options in the seating capacity section 113. Once all of the information for that table is entered, the host station 12 prompts the programmer to select the placement for the next table to locate and program. These steps are repeated until all of the tables and types are properly located in the pallet 113 of the table set-up screen to resemble the table configuration of the restaurant. Once all tables are properly located and configured, the programmer can save the pallet configuration by clicking the “SAVE” button. If a table is not located properly or incorrect information for that table has been entered, the programmer clicks the “EDIT” button then chooses the table to edit. When the programmer is finished editing the table, the programmer clicks “SAVE” to finish and save.

The seating management system provides a real-time status of usage of the table based on information from the table transmitters 24 to show the availability and status of each table as illustrated on the seating management screen depicted in FIG. 22. Tables displayed in GREEN (shown by square hatching) are visually identified as “available” tables. Tables displayed in RED (shown with angular hatching) are visually identified as “Occupied” tables. Finally, tables displayed as YELLOW (shown with circular hatching) are visually identified as tables that “Need Cleaning” in preparation for reseating of the tables.

Along with the visual display, of the seating status, of any given table in the dining room, each table's individual statistics can be obtained simply by clicking on that table from the seating management screen. The information displayed for an individual table is the table number, seating capacity, smoking preference, and the duration of the current status of the table. For example, if the table is listed as “occupied” then the duration time showing how long the table has been “occupied” is shown on the display.

The zoning management system of the host station 12 allows the restaurant to change the server coverage configuration quickly with the press of a button as illustrated on the screen depicted in the zoning management screen of FIG. 23. When the manager needs additional servers to work the dining room due to increased customer traffic, additional servers can be added to the current configuration. The host station 12 stores a pre-programmed set of server configurations that are previously input at initial set-up. Across the bottom of the screen are buttons designated “1 Svr” through “50 Svr”. These buttons allow the manager to select the number of servers working the dining room by selecting the appropriate number of servers button. For Example, if the manager currently has 2 servers working and needs to add two more. The manager will simply select the “4 Svr” button then select the “Program” button. This will reconfigure the table transmitters 24 and which mobile receivers 26 the table transmitters 24 message.

The zoning management program has the ability to change which table transmitters 24 message certain mobile receivers 26 on a one-time basis. The user selects the table from the zoning management screen to be changed to a different server and selects the new server or mobile receiver of the new server. The user will select the “1 TIME” button then select the “Program” button. This will change the mobile receiver 26 that the table transmitter 24 messages. This change will only be in effect until the current party occupying the table has finished, and the table transmitter 24 has cycled through the seating management program. After the party leaves and the table is cycled, the table transmitter 24 will revert back to messaging the mobile receiver 26 of the original server that the permanent programming selected.

Regular permanent programming can be edited with the “EDIT” button. When the user selects the “EDIT” button and one of the “Pager” buttons on the right side control panel, the current programming for that mobile receiver 26 will be displayed. Tables can be deselected or new tables can be selected to add or delete from the permanent programming for that mobile receiver 26. The user will then select the “Save” button to change the programming for that mobile receiver 26.

The timing management program is a program that offers the management or hostess access to timing statistics of individual tables as well as a table overview as illustrated on the time management screen depicted in FIG. 24. The time management screen allows the manager or hostess to more accurately gauge the timing of table availability in a scientific manor rather than taking the traditional “educated guess”. This general overview of table usage also allows the management or hostess an easy alternative to eliminate wasted time roaming the restaurant looking for the next available seating. The timing management program starts a clock the instant a guest is seated. This clock is started once the seating management program is notified that the table is “Occupied.” When the table becomes occupied, the clock, which counts down from a predetermined average dining time, will accurately time the portion of the guests dining experience from the time the table is occupied to the time the table is vacated. A graphic clock for each table is displayed by the host station 12 in the form of the table icon 34 on the time management screen. This icon will change color from top to bottom, much like an hourglass to indicate the countdown of time starting from the preprogrammed average dining time. With this information, over time, an accurate average, to the second, can be obtained for the guests' average dining time. By selecting any one of the table icons 34, detailed information will be displayed about that table in the table info section of the time management screen. Information contained in the table info section will let the hostess or manager know the table specific data including the duration of current table seating status.

When a guest is seated, the host station 12 begins a counting down of the countdown timer for that table and displays the counting down of time of the time management screen. For example, if the average dining time of a restaurant is 45 minutes per table, the countdown timer will start at 45 minutes when a guest is seated. A visual display starting at 45 minutes (based on the earlier hypothetical) and counting down backwards from that time will indicate how much time is left for that guest. The timing management program will then be able to display the countdown timers of all occupied tables. This function of the time management screen will allow the hostess or manager to have a comprehensive overview of the status of all tables in the restaurant, and which are due to be finished soon. This provides the manager or hostess a more accurate way to gauge the next available table that meets the next waiting guest's seating criteria, i.e., number of guests, seating preference and smoking preference.

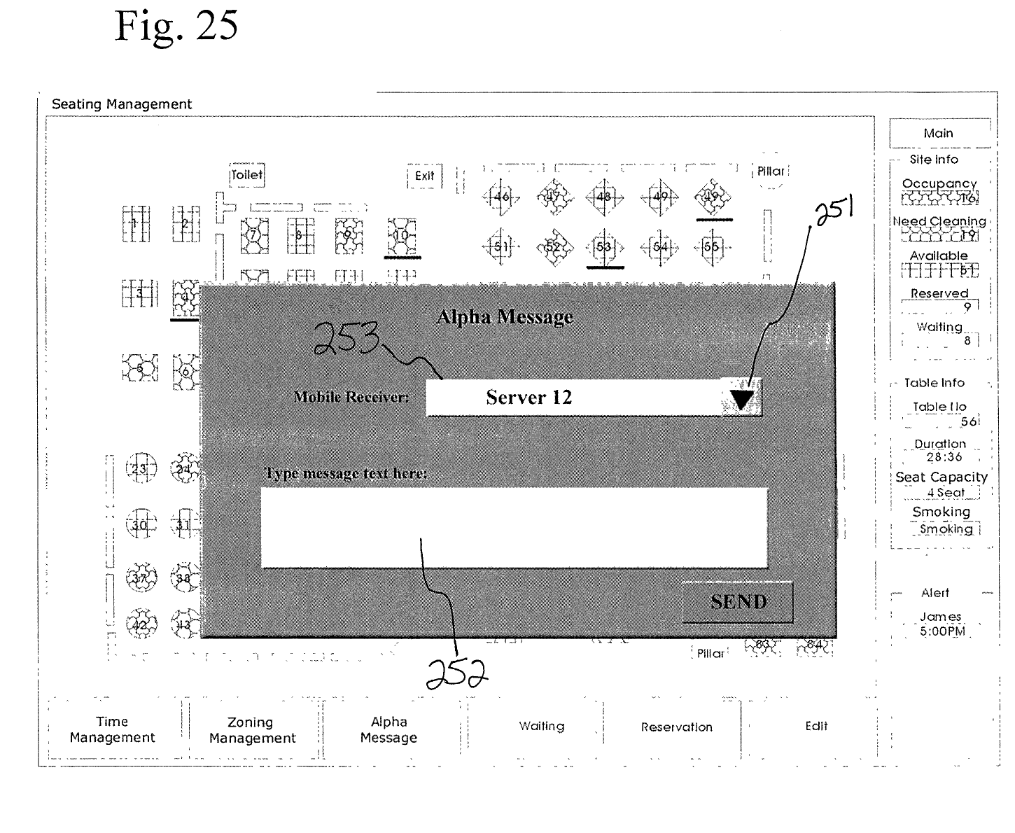

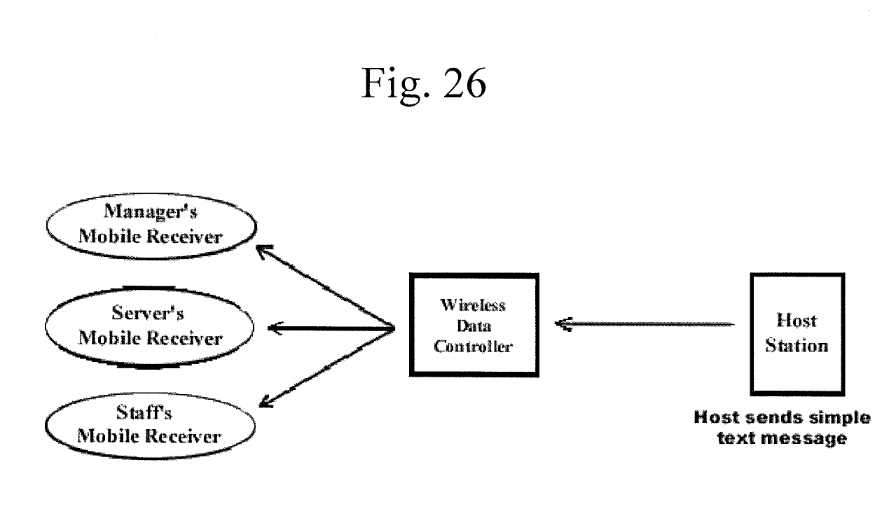

The system also includes a message function that allows the host/hostess or manager to send a simple text message to any or all mobile receivers 26 as shown in FIG. 25. A flow chart of the functionality of the messaging is shown in FIG. 26. On the seating management program screen, the user selects the message function at the bottom of the screen. The user can select the mobile receiver or receivers 26 to be the recipient from a pull-down window, activated by a button 251. After the user selects the recipients, text can be typed into the free text block 252 below the recipient selection window 253. After the text message is typed in, the user selects the “SEND” button to send the message.

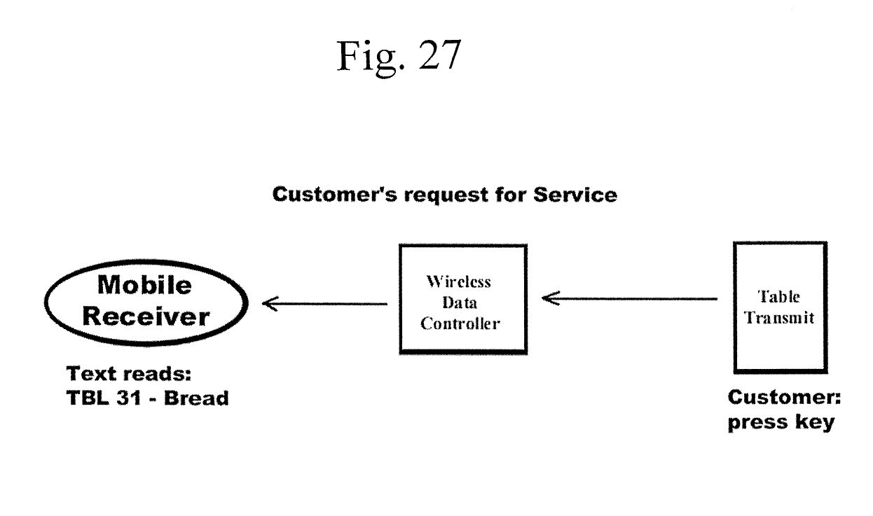

The system also includes a customer request function, in which the customer makes a request by pressing one of the six programmable buttons on the table transmitter 24 as shown in the flowchart of FIG. 27. The server receives the message along with the customer's table number. (For Example, “TABLE 23—CHECK”) This allows the server to respond to the request promptly without any unnecessary trips.

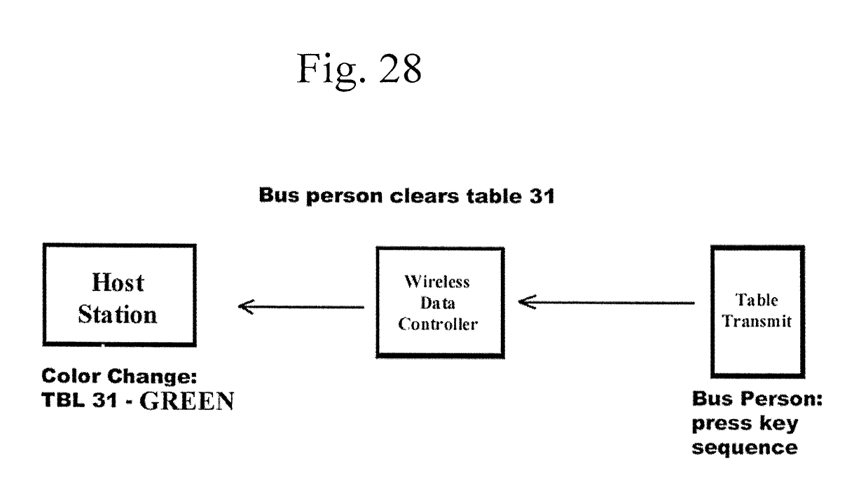

After the table is cleaned, the bus staff presses a key sequence on table transmitter 24 initiated by the “Shift” key as shown in the flowchart of FIG. 28. On the host station 12 the table displays the table number and status as “GREEN”, which indicates that the table is cleaned and available for seating.

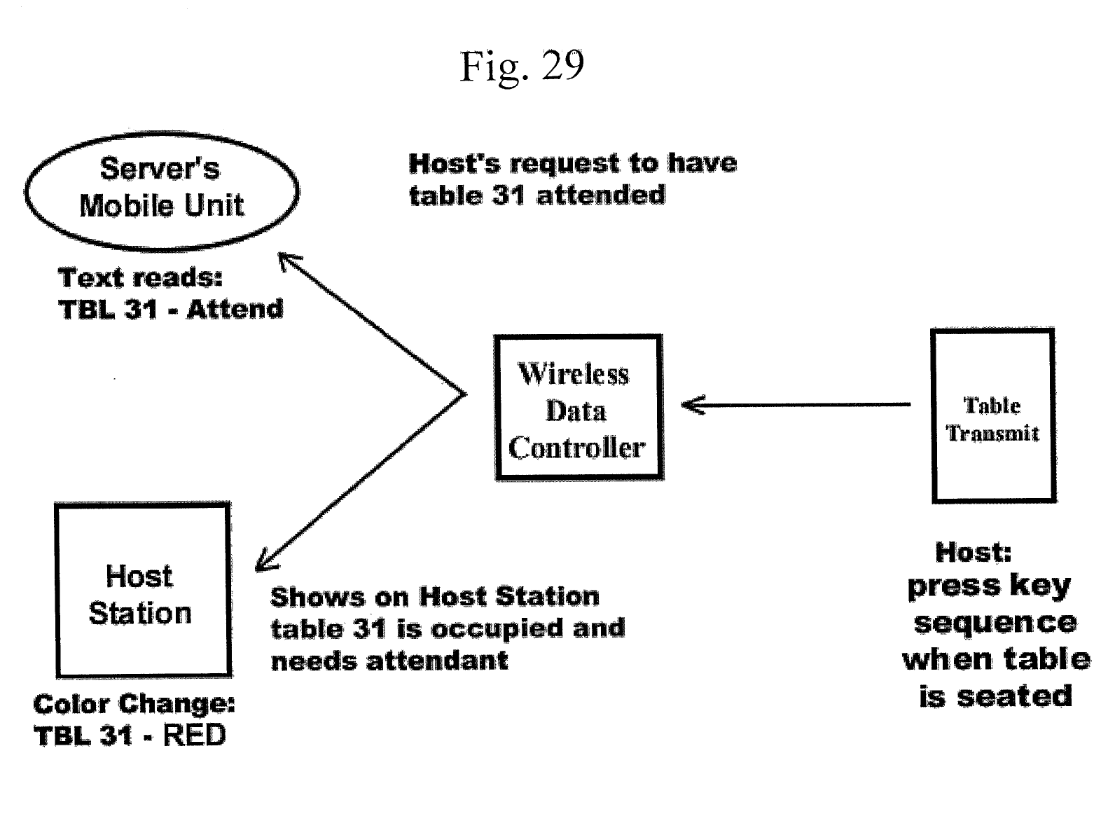

When the table is seated, the host/hostess hits a key sequence on the table transmitter 24 initiated by the “Shift” key as shown in the flowchart of FIG. 29. This sends a notification to the host station 12 that the table is occupied which changes the display of the table to “RED”. Concurrently a message is also sent to the designated server's mobile receiver 26 notifying the server that a guest has been seated at the table and needs immediate attendance.

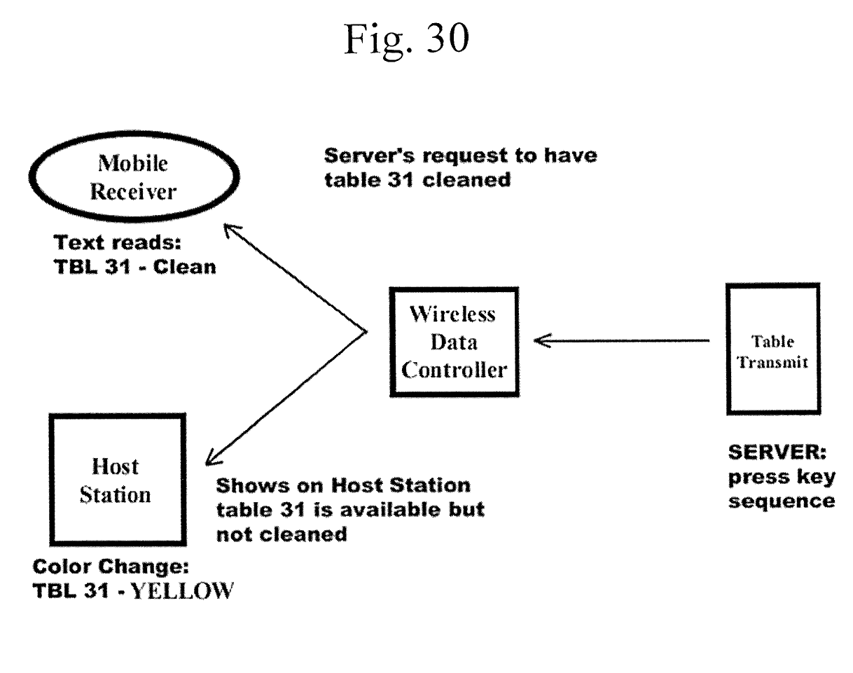

When the patrons have departed, the server presses a button sequence on the table transmitter 24 initiated by the “Shift” key as shown in the flowchart of FIG. 30. This notifies host station 12 that the table guests have departed and changes the display of the table to “YELLOW”. At the same time a notification is sent to the bussing staff, notifying them that Table 31 needs to be cleaned in preparation for reseating.

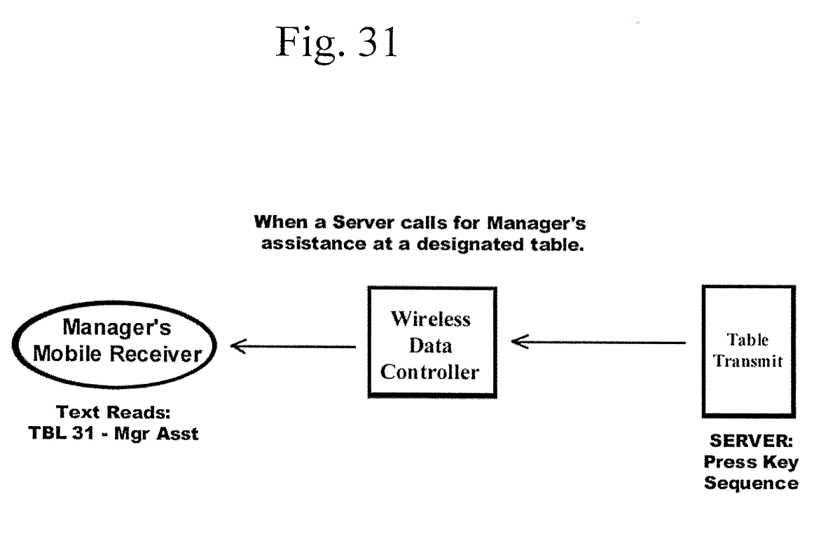

A manager call function allows a server to send a call to management's mobile receiver 26 when assistance at a designated table is needed as shown in the flowchart of FIG. 31. This message is sent via a key sequence on the table transmitter 24 initiated by the “Shift” key.

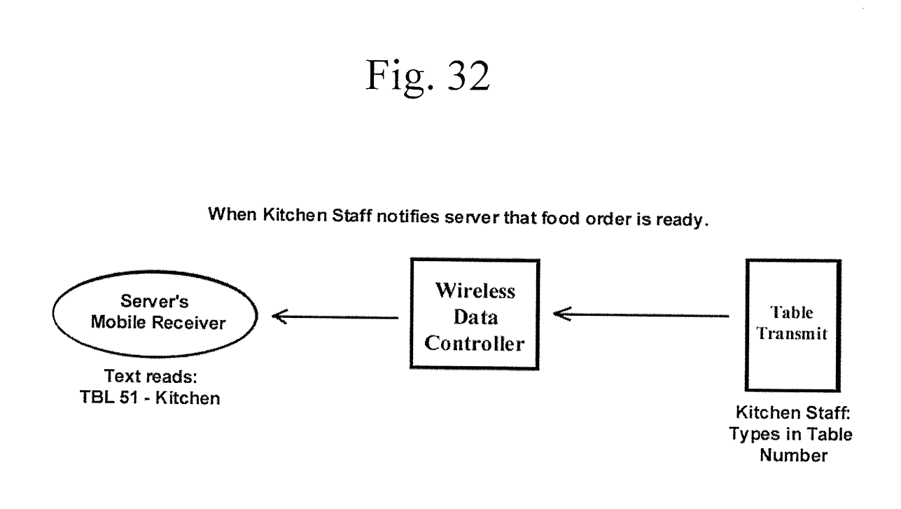

When food for a particular table is ready for delivery, the kitchen staff notifies the server or floater through the station transmitter 44 as shown in the flowchart of FIG. 32. When the order is ready, the user will type in the destination table number of the order using the keypad on the station transmitter 44. The station transmitter 44 sends the message through the wireless data controller 36, which determines the proper server's mobile receiver 26 to receive the message and sends the message to the appropriate mobile receiver 26. The message will display that food for that particular table is ready for delivery. This eliminates wasted time for the server, who no longer has to wait in the kitchen for orders to be ready.

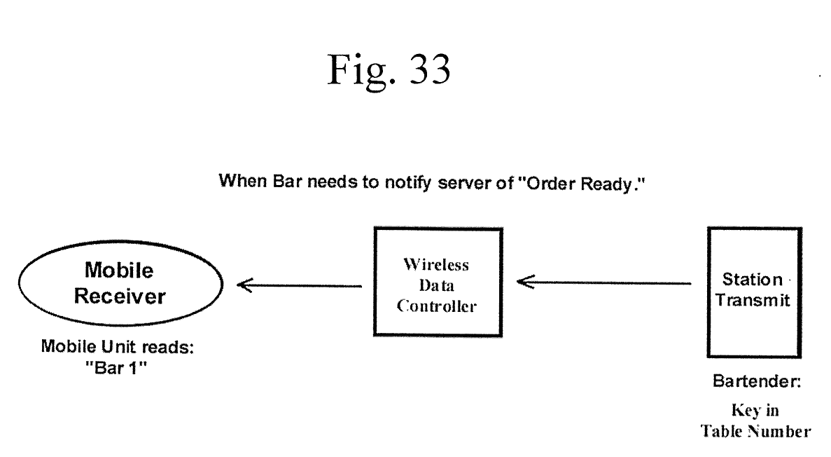

When the bar needs to send a call to notify a server that an order is ready, the station transmitter 44 is used as shown in the flowchart of FIG. 33. When the drink order is ready, the user will type in the destination table number of the order using the keypad on the station transmitter 44. The station transmitter 44 sends the message through the wireless data controller 36, which determines the proper server's mobile receiver 26. The message will display that the drink order for that particular table is ready for delivery. This eliminates the time wasted by servers waiting at the bar for orders to be filled.

The system includes a request block function, which is a function of the seating management software that allows management to block repeated requests to servers' mobile receivers 26 from 1 to 15 minutes, blocking annoying, repeated requests by customers made via the table transmitter 24.

The system also includes a table ID function, which is a function of the initial setup program that allows the table transmitters 24 to have table numbers changed when the table transmitter 24 is moved or replaced. This function provides an easy method for replacement of table transmitters 24 when necessary.

The table transmitters can include a tamper-proof request button. The tamper-proof request button feature prevents children, from playing with the buttons on the table transmitter 24. In order to make a request on the table transmitter 24, the button must be pressed and held for a preprogrammed time period to be determined by the management. When the buttons on the table transmitter 24 are held down for the appropriate period of time, a green LED will light to indicate that the request was transmitted to the server's mobile receiver 26. Since children will most likely press the buttons and not hold them down, this feature hinders children from playing with the buttons and sending an unauthorized request to the server.

A hidden shift button allows the button pad 42 of the table transmitter 24 to have additional functionality. This feature is primarily used to initiate internal communications. When the hidden button is engaged, the keypad 42 of the table transmitter 24 will allow the buttons to be utilized for additional internal requests.

The system includes a zone delay timing feature, which is a feature of the zoning management program. On the zoning management program screen (FIG. 23), the “zone delay timing” is selected when a zoning change occurs. This will allow tables, which are selected, to be reassigned to a different server, due to a zoning change to remain with the original server. If a guest is currently under the care of a server, this feature provides a way for the server to finish service at that table before it is changed to the server currently working that zone. The table will be rezoned when it goes through the normal stages of the seating management program. When the table is cleaned and ready for reseating, it will show up as GREEN on the seating management program. At that point the table will show as “ready for reseating under the proper server's zone.

Without changing the entire zoning programming, the designated table can be transferred to a different server until the guests leave by using the “one-time” server change function. The table will then revert to the correctly assigned server. For example, a waiting party of eight requires that two four-top tables be placed together to accommodate this seating arrangement. The only two tables available, located next to each other, are assigned to separate servers. One of the two tables can be temporarily assigned to the other server so that a single server services the party of eight. After that party departs, the tables will revert back to their original server assignments.

The system also includes a reservation reminder and reservation alert function, which allows for reservations to be accepted and displayed on the host station 12, notifying the management or staff of impending reservations. The reservation can be input to the seating management program. The reservation reminder will pop-up a reminder to be displayed on the host station 12 at a preprogrammed lead time, such as 30 minutes, prior the reserved time, as a reminder of the reservation. This will serve as a preliminary notification of the reservation. A reservation alert will then alert the management or staff that the impending reservation needs to be assigned to a table. This alert is will display a visual indicator on the screen at a designated lead time, such as 10 minutes prior to the reserved time. This serves to prompt the management or staff to reserve a table for the arriving party. The hostess will be able to accept the reservation of the party if present or cancel the reservation in the event the guests are not present.

The smart programming of the system reconfigures the table transmitter 24 and which mobile receiver 26 the table transmitter 24 messages. However, these changes will not take effect on those tables already occupied until the table transmitters 24 have cycled through the seating management stages for dining such as “occupied”, “needs cleaning” and “ready for seating”. This independent reprogramming capability by the system is referred to as “smart programming”. “Smart programming” is the ability of the system to reprogram table transmitters 24 to message intended mobile receivers 26 after the table transmitter 24 has cycled through the seating management stages. Through the use of this “smart programming”, changes can be made to a server's coverage configuration without disturbing customers already sitting at tables.

The system also includes an out of service notification, which is an alert that causes the mobile receiver 26 to chirp when the unit is removed from the wireless coverage area, thus preventing the units from being taken home accidentally by the staff.

The system also includes a report and evaluation function in which the host station 12 performs various calculations based on the information related to the tables and presents the information in the form of reports according to the desire of the manager. The report and evaluation function allows managers to evaluate all operations, especially individual servers' efficiency. Managers can monitor type, quantity and frequency of calls to a server. Data can also be extracted relative to table timing. The reporting and evaluation feature can be divided into two main categories, post event reporting and real-time alerts.

Post Event Reporting

1. Total Table Turn

In the total table turn report, the host station 12 calculates and reports how many table turns, or guests, have been served, either individually by table or by total table turned within the establishment. The manager can specify a time period to view as well. For example, the host station can be instructed to report the number of table turns that occurred between 5:00 PM to 7:00 PM on Fridays.

2. Average Dining Time

The average dining time option can be selected as an on or off option at the time of initial programming. At initial programming, the time is set to a selected range of days, for example, 11:00am to 2:00pm, from April 1^{st} to April 8^{th}, or selected days, for example, 5:00pm to 11:30pm every Thursday, Friday and Saturday, from April 1^{st} to April 30^{th}. For the average dining time report, the host station 12 calculates and displays the average dining time, for the average guest, over the selected time periods. This report allows the manager to have an accurate average of how long it takes a guest to dine within a specified date range.

3. Average Table Wait to Clean Time

The average table wait to clean time report allows the manager to view the efficiency and effectiveness of the bussing staff. An average of how long it takes a table to be bussed is generated and displayed by the seating management program of the host station 12.

4. Total Call

The host station 12 also includes a total call report in which the host station 12 tracks and provides information on how many calls were made to servers by category. Each table transmitter 24 has six programmable request buttons that send specific requests to their assigned server. These requests are monitored and recorded by the host station 12 for management purposes. The total call report allows the manager to see how many calls, and of what type the table transmitters 24 generate, thus providing a comprehensive view of what requests are made most often.

5. Average Call Count

The host station 12 also includes an average call count report in which the host station 12 tracks and provides information on how many calls were made to servers by category. Each table transmitter 24 has six programmable request buttons that send specific requests to their assigned server. These requests are monitored and recorded by the host station 12 for management purposes. The average call count report allows the manager to see how many calls, and of what type the table transmitters 24 generate for each individual server, thus providing a comprehensive view of what requests are made most often to a specific server. With the average call count report, the host station 12 also calculates and provides information on the number of calls each server gets per table on average.

6. Detail Request

The host station 12 also includes a detail request report in which the host station 12 generates a detailed breakdown of specific requests made to specific servers by table. The detail request report provides the manager with a detailed report of call frequency and type for individual servers and tables.

7. Frequency of Manager Call

The host station 12 also includes a frequency of manager call report in which the host station 12 tracks and provides information on how many times the manager was summoned to tables by servers during a specified time period. The frequency of manager call report provides information on how servers are interacting with customers, and of any problems or praise that are a result of that interaction.

8. Frequency of Manual Override

The host station 12 also includes a frequency of manual override report in which the host station 12 tracks and provides information on how many times a host/hostess has to change the table dining status in the seating management software on the host station 12 manually. For example, if a table needs to be changed from a seated status, which is represented by a red table icon on the seating management software, to an unoccupied and ready for reseating status, which is represented by a green table icon on the seating management software, this action is recorded and reported by the host station 12.

Real-Time Alerts

9. Repeat Request

The table transmitter 24 includes a repeat request report in which the table transmitter 24 detects when a request is sent more than once within a predefined time period on the table transmitter 24. When the table transmitter detects that a request has been sent more than one within the predefines time period, the table transmitter 24 sends an instantaneous alert to management's mobile receiver 26.

10. Quantity of Over Time on “Needs Cleaning” Status

The host station 12 also includes quantity of over time on “needs cleaning” status alert in which the host station alerts the manager when tables have exceeded the maximum allowable time period for being cleaned. The parameters for this time period are set in the initial program settings. If the manager feels that a table should be cleaned and ready for reseating in five minutes, for example, the host station 12 alerts the manager immediately of violations, and the issue can be addressed and corrected by the manager.

11. Excessive Request

The host station 12 also includes an excessive request alert in which the host station 12 detects and alerts the manager when a customer makes more than a predefined number of calls within a single table turn. The excessive request alert allows the manager to be aware of excessive calls to a server from an individual table.

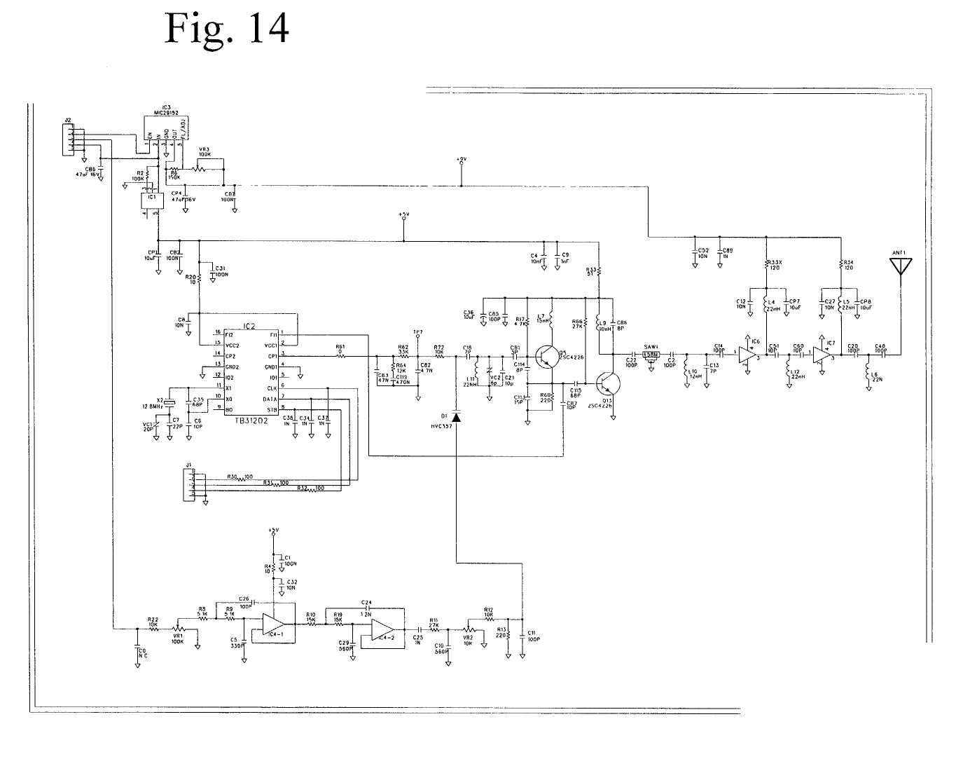

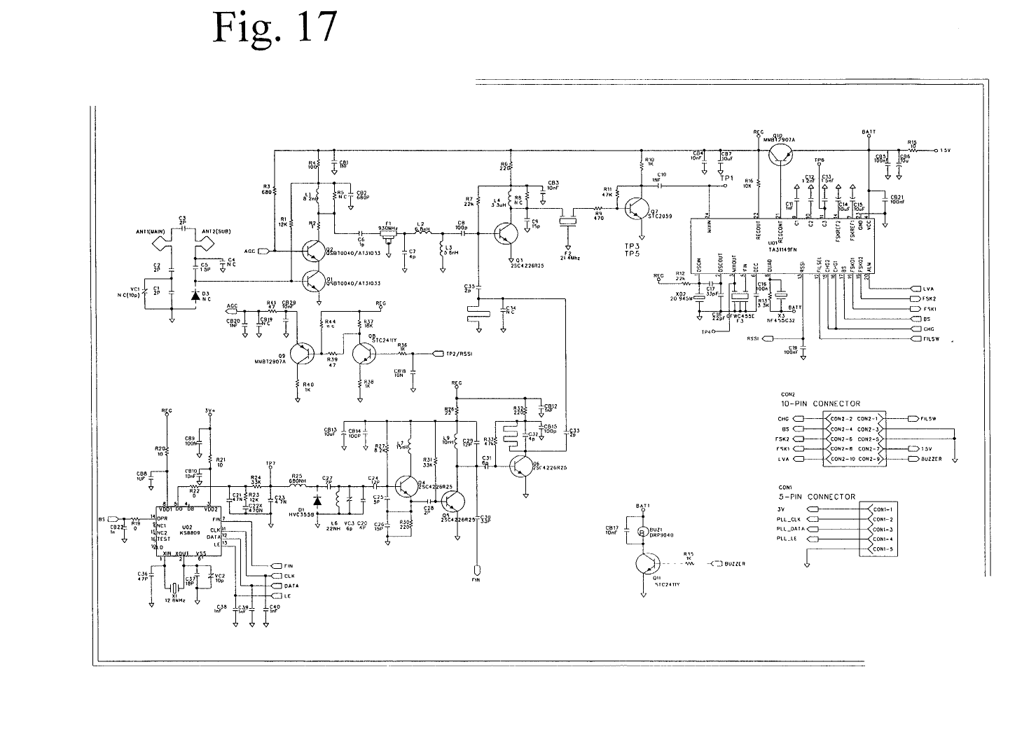

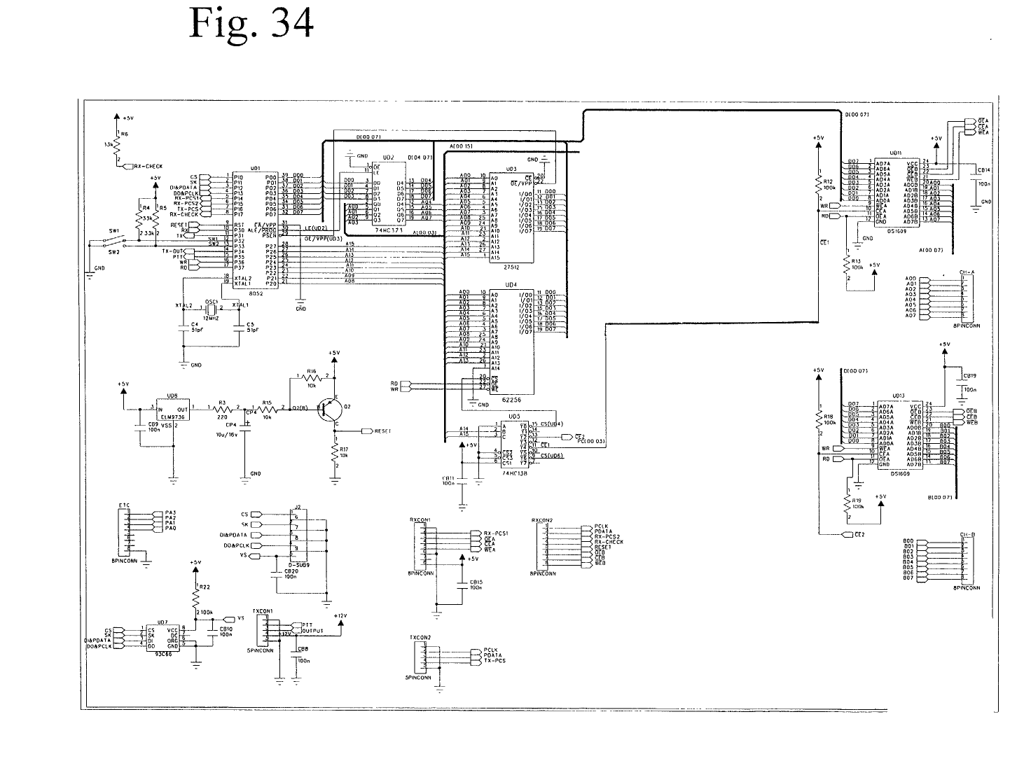

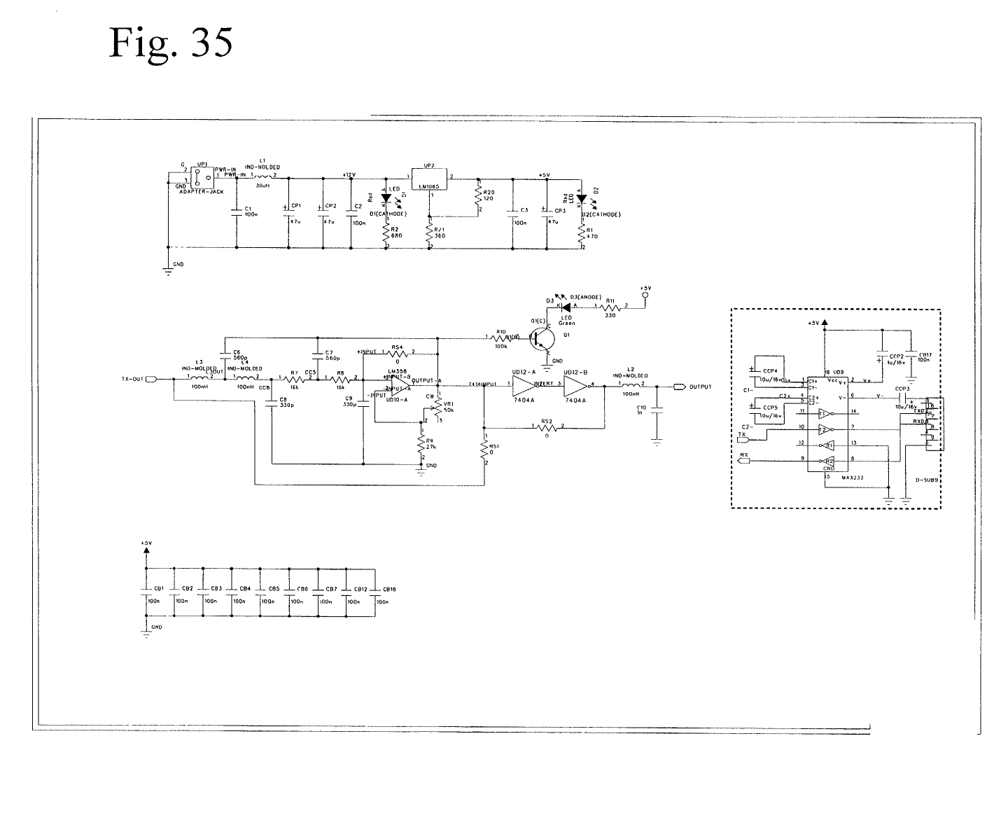

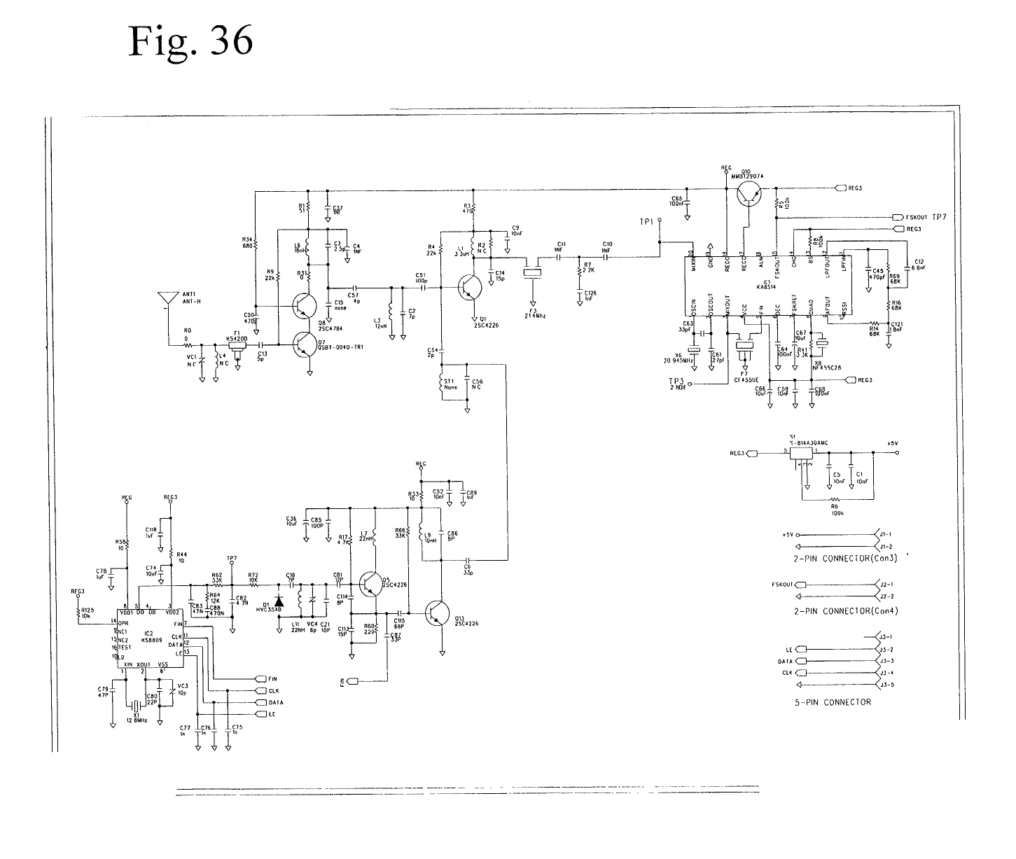

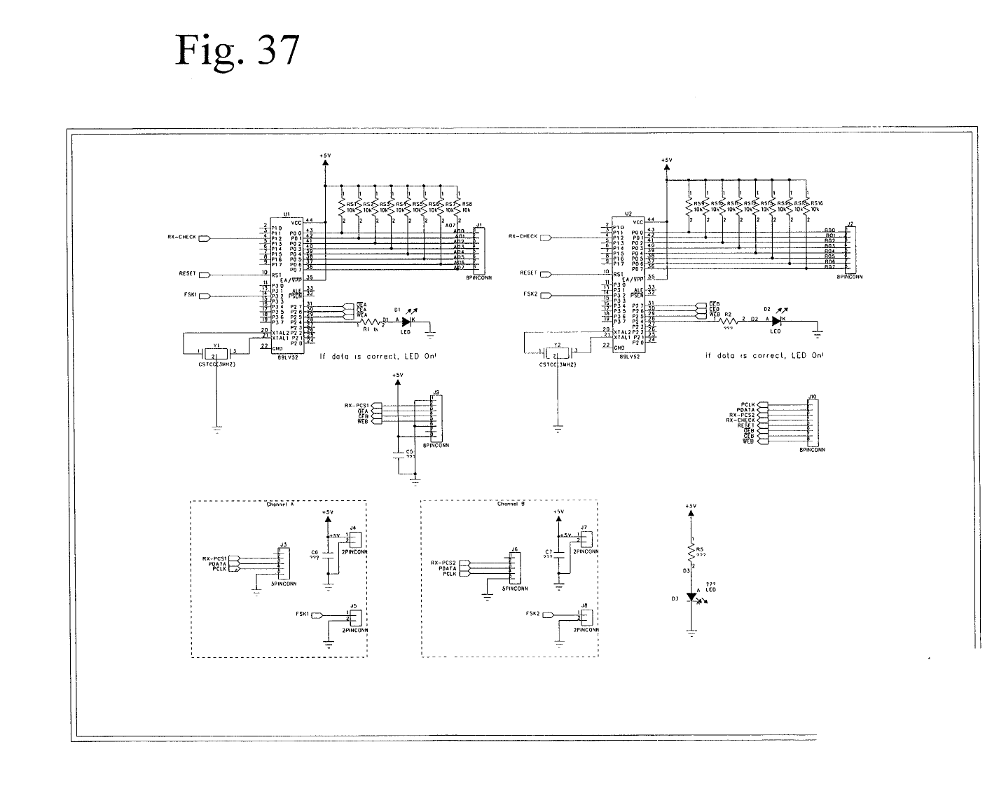

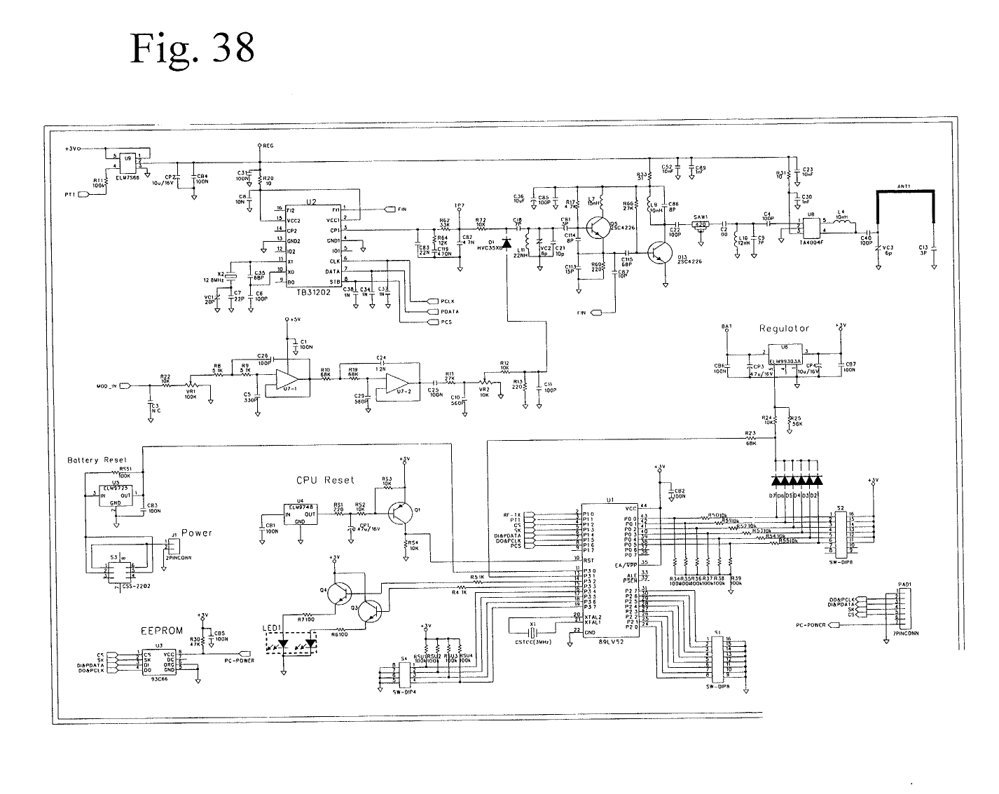

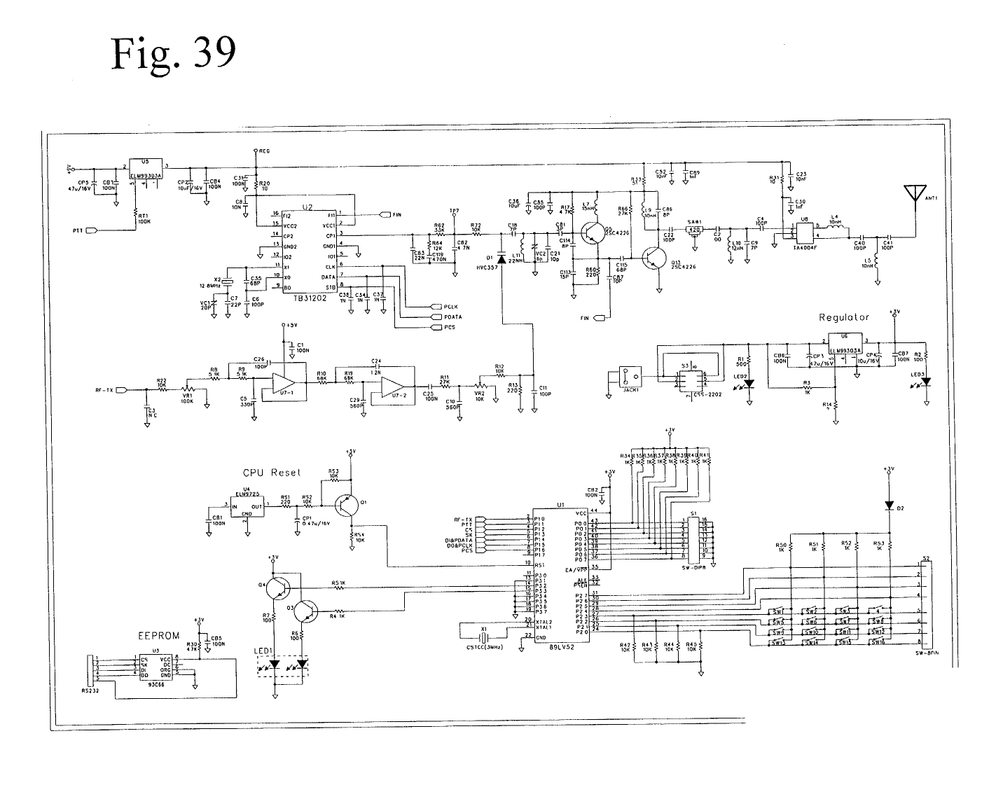

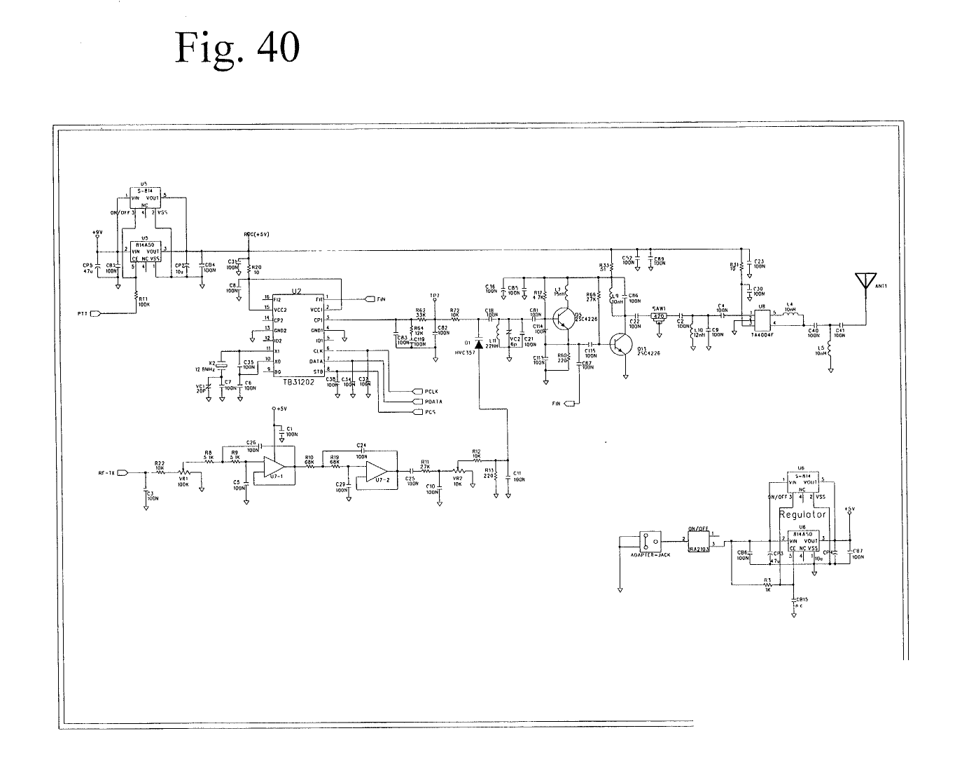

FIGS. 14, 16, 17, and 34-40 are exemplary circuit wiring diagrams of elements of the system described above. The circuit diagrams show exemplary components and are presented in a manner in which a person having ordinary skill in the art would be able to make and use the exemplary components. Thus, because the diagrams themselves present an enabling disclosure to a person of ordinary skill in the art, no further description is necessary. FIG. 14 is an exemplary circuit diagram of a transmission part of a wireless data controller of the present invention. FIGS. 16 and 17 are exemplary circuit diagrams of a mobile receiver according to the present invention. FIG. 34 is an exemplary circuit diagram of a wireless data controller circuit of the present invention. FIG. 35 is an exemplary circuit diagram of a power part of a wireless data controller of the present invention. FIG. 36 is an exemplary circuit diagram of an RF part of a wireless data controller of the present invention. FIG. 37 is an exemplary circuit diagram of a receiving part of a wireless data controller of the present invention. FIG. 38 is an exemplary circuit diagram of a table transmitter of the present invention. FIG. 39 is an exemplary circuit diagram of a station transmitter of the present invention. FIG. 40 is another exemplary circuit diagram of a station transmitter of the present invention.

The above description is not intended to be limiting, but rather to describe the preferred embodiments of the present invention. The functions of the system can be accomplished by dedicated hardware or by computers running software programs written on a computer readable medium and written according to known programming methods. Obvious variations of the invention described above, and recited in the following claims, are considered to be within the scope of the present invention.

1. A wireless data management system, for use in a restaurant including a plurality of tables and for use by users, including restaurant employees and customers, said system comprising:
a plurality of table transmitters, each to be located at a respective table of the plurality of tables, each table transmitter including an input device operable to receive data input by a user, and each table transmitter being operable to receive the data input through its input device and to wirelessly transmit the data;
a host station including a display device and an input device, said host station being operable to receive data input through its input device; and
a wireless data controller operable to wirelessly receive the data transmitted by said table transmitters, and to send data received from said table transmitters to said host station;
wherein said host station is operable to:
receive the data from said table transmitters via said wireless data controller,
display, on said display device of said host station, a graphical representation of an area of the restaurant including a graphical representation of the tables located within the graphical representation of the area of the restaurant so as to represent the physical location of the tables in the restaurant, and
display, on said display device of said host station, information related to the tables based at least in part on the data received from said table transmitters.

2. A wireless data management system according to claim 1, wherein:
each said table transmitter is operable to receive a table-available indication through its input device indicating that the respective table is available for seating customers and, after the table-available indication is received, to wirelessly transmit the table-available indication;
said wireless data controller is operable to wirelessly receive table-available indications transmitted by said table transmitters and to send the received table-available indications to said host station; and
said host station is operable to receive table-available indications from said wireless data controller and to display, on said display device of said host station in response to reception of a table-available indication, a visual indication that the respective table is available.

3. A wireless data management system according to claim 2, wherein said host station displays the indication that the respective table is available by changing the color of the graphical representation of the respective table to a color that, according to a predetermined legend, indicates that the table is available.

4. A wireless data management system according to claim 3, wherein said host station displays the indication that the respective table is available by changing the color of the graphical representation of the respective table to green.

5. A wireless data management system according to claim 1, wherein:
each said table transmitter is operable to receive a table-occupied indication through its input device indicating that the respective table is occupied and, after the table-occupied indication is received, to wirelessly transmit the table-occupied indication;
said wireless data controller is operable to wirelessly receive table-occupied indications transmitted by said table transmitters and to send the received table-occupied indications to said host station; and
said host station is operable to receive table-occupied indications from said wireless data controller and to display, on said display device of said host station in response to reception of each table-occupied indication, a visual indication that the respective table is occupied.

6. A wireless data management system according to claim 5, wherein said host station displays the indication that the respective table is occupied by changing the color of the graphical representation of the respective table to a color that, according to a predetermined legend, indicates that the respective table is occupied.

7. A wireless data management system according to claim 6, wherein said host station displays the indication that the respective table is occupied by changing the color of the graphical representation of the respective table to red.

8. A wireless data management system according to claim 5, wherein said host station is operable to:
store an average dining time;
start a counting down of a table clock, for each table for which a table-occupied indication has been received, to count down from the average dining time; and
indicate the counting down of one or more of the table clocks on said display device of said host station.

9. A data communication system according to claim 8, wherein said host station is operable to display one or more of said table clocks on said display device of said host station such that each of the table clocks is displayed in association with a corresponding table.

10. A data communication system according to claim 8, wherein said host station is operable to gradually change the appearance of the graphical representation of a table in accordance with the counting down of the table clock corresponding to the table so as to indicate the counting down of the table clock corresponding to the table.

11. A data communication system according to claim 8, wherein said host station is operable to gradually change the appearance of the graphical representation of a table in accordance with the counting down of the table clock by gradually changing the color of the graphical representation of the table in accordance with the counting down of the clock.

12. A data communication system according to claim 11, wherein said host station gradually changes the color of the graphical representation of a table by gradually changing the color from the top of the graphical representation of the table to the bottom of the graphical representation of the table.

13. A wireless data management system according to claim 1, wherein:
each said table transmitter is operable to receive a needs-cleaning indication through its input device indicating that the respective table needs cleaning and to wirelessly transmit the needs-cleaning indication;
said wireless data controller is operable to wirelessly receive needs-cleaning indications transmitted by said table transmitters and to send the needs-cleaning indications to said host station; and
said host station is operable to receive the needs-cleaning indications from said wireless data controller and to display, on said display device of said host station in response to reception of each needs-cleaning indication, a visual indication that the respective table needs cleaning.

14. A wireless data management system according to claim 13, wherein said host station displays the visual indication that the respective table needs cleaning by changing the color of the graphical representation of the respective table to a color that, according to a predetermined legend, indicates that the respective table needs cleaning.

15. A wireless data management system according to claim 14, wherein said host station displays the indication that the respective table needs cleaning by changing the color of the graphical representation of the respective table to yellow.

16. A wireless data management system according to claim 1, wherein:
said host station is operable to store statistical information related to the table, and to display the statistical information on said display device of said host station in response to a request for display of the statistical information input by a user through said input device of said host station.

17. A wireless data management system according to claim 16, wherein said display device and said input device of said host station comprise a touch-screen monitor operable to detect a touching by the user of the graphical representation of the table as the request for display of the statistical information.

18. A wireless data management system according to claim 16, wherein the statistical information comprises table number, seating capacity, smoking preference, and duration of current seating status.

19. A wireless data management system according to claim 1, comprising:
a plurality of mobile receivers, each to be used by a server-person assigned to one or more of the tables;
wherein said wireless data controller stores transmitter/receiver association data indicating which of said table transmitters is associated with each of said mobile receivers, and
said wireless data controller is operable to wirelessly transmit data received from said table transmitters to said mobile receivers in accordance with the transmitter/receiver association data.

20. A wireless data management system according to claim 19, wherein said wireless data controller is operable to wirelessly transmit data, received from said host station, to said mobile receivers.

21. A wireless data management system according to claim 19, wherein
each said table transmitter is operable to receive a table-occupied indication through its input device indicating that the respective table is occupied and to wirelessly transmit the table-occupied indication;
said wireless data controller is operable to wirelessly receive table-occupied indications transmitted by said table transmitters and to wirelessly transmit the received table-occupied indications such that the wirelessly transmitted table-occupied indications are addressed to said mobile receivers in accordance with the transmitter/receiver association data; and
each said mobile receiver is operable to wirelessly receive a table-occupied indication transmitted by said wireless data controller and to provide to the server, in response to reception of the table-occupied indication, an indication that the respective table is occupied.

22. A wireless data management system according to claim 19, wherein the restaurant with which the system is used includes at least one preparation area, said wireless data management system comprising:
at least one station transmitter, to be located at a respective preparation area of the at least one preparation area, respectively, each station transmitter including an input device operable to receive data input by a user and each station transmitter being operable to receive the data input through its input device and to wirelessly transmit the data.

23. A wireless data management system according to claim 22, wherein:
said station transmitter is operable to receive an order-ready indication through its input device indicating that an order made to the respective preparation area is ready, and to wirelessly transmit the order-ready indication;
said wireless data controller is operable to wirelessly receive the order-ready indication transmitted by that said station transmitter and to wirelessly transmit the order-ready indication such that the wirelessly transmitted order-ready indication is addressed to said mobile receiver; and
said mobile receiver is operable to wirelessly receive the order-ready indication transmitted by said wireless data controller and to provide to the server, in response to reception of the order-ready indication, an indication that the order is ready.

24. A wireless data management system according to claim 23, wherein said wireless data controller is operable to send the order-ready indication to said host station, and said host station is operable to receive the order-ready indication from said wireless data controller.

25 A wireless data management system according to claim 19, wherein said host station stores a pre-programmed set of server configurations, each server configuration providing an assignment of tables to servers such that the tables are divided among a number of servers and providing a corresponding transmitter/receiver association data indicating which of said table transmitters is associated with each of said mobile receivers according to the assignment of table to servers of the respective server configuration, and said host station is operable to apply one of the server configurations in accordance with a configuration choice input by a user through said input device of said host station.

26. A wireless data management system according to claim 25, wherein each of the server configurations of the pre-programmed set of server configurations provides an assignment of some or all of the plurality of tables among a different number of servers, such that a change in the server configuration by the user changes the number of servers among which assignment of the tables is divided.

27. A wireless data management system according to claim 25, wherein said host station is operable to:
display a plurality of server-number buttons, each indicating a different number of servers;
store button/configuration correspondence data indicating a correspondence between each server-number button and a respective server configuration, wherein the server-number buttons indicate the number of servers among which the assignment of tables is divided in the server configuration corresponding to the server-number buttons, respectively;
receive the configuration choice by detecting a user's touch of one of the server-number buttons; and
apply the server configuration corresponding to the server-number button touched by the user according to the stored button/configuration correspondence data.

28. A wireless data management system according to claim 19, wherein:
said host station is operable to set in said wireless data controller a one-time temporary transmitter/receiver association between one or more of said table transmitters and one of said mobile receivers, wherein the one-time temporary transmitter/receiver association lasts through one seating cycle of the table or tables corresponding to the one or more table transmitters included in the one-time association, or through the end of a current seating cycle of the table or tables corresponding to the one or more table transmitters included in the one-time association.

29. A software program embodied on a computer readable medium, for use with a computer having a display device, said software program being operable to instruct the computer to:
display, on the display device of the computer, a graphical representation of an area of a restaurant including a graphical representation of tables located within the graphical representation of the area of the restaurant so as to represent the physical location of the tables in the restaurant, and
display, on the display device of the computer, information related to the tables based at least in part on data received from table transmitters located at the tables, respectively.

30. A software program according to claim 29, wherein said software program is operable to instruct the computer to receive table-available indications, which each indicate that a respective table is available for seating customers, and to display, on the display device of the computer in response to reception of a table-available indication, a visual indication that the respective table is available.

31. A software program according to claim 30, wherein said software program is operable to instruct the computer to display the indication that the respective table is available by changing the color of the graphical representation of the respective table to a color that, according to a predetermined legend, indicates that the table is available.

32. A software program according to claim 31, wherein said software program is operable to instruct the computer to display the indication that the respective table is available by changing the color of the graphical representation of the respective table to green.

33. A software program according to claim 31, wherein said software program is operable to instruct the computer to receive table occupied indications, which indicate that a respective table is occupied and to display, on the display device of the computer in response to reception of each table-occupied indication, a visual indication that the respective table is occupied.

34. A software program according to claim 33, wherein said software program is operable to instruct the computer to display the indication that the respective table is occupied by changing the color of the graphical representation of the respective table to a color that, according to a predetermined legend, indicates that the respective table is occupied.

35. A software program according to claim 34, wherein said software program is operable to instruct the computer to display the indication that the respective table is occupied by changing the color of the graphical representation of the respective table to red.

36. A software program according to claim 35, wherein said software program is operable to instruct the computer to:
store an average dining time;
start a counting down of a table clock, for each table for which a table-occupied indication has been received, to count down from the average dining time; and
indicate the counting down of one or more of the table clocks on the display device of the computer.

37. A software program according to claim 36, wherein said software program is operable to instruct the computer to display one or more of said table clocks on the display device of the computer such that each of the table clocks is displayed in association with a corresponding table.

38. A software program according to claim 36, wherein said software program is operable to instruct the computer to gradually change the appearance of the graphical representation of a table in accordance with the counting down of the table clock corresponding to the table so as to indicate the counting down of the table clock corresponding to the table.

39. A software program according to claim 36, wherein said software program is operable to instruct the computer to gradually change the appearance of the graphical representation of a table in accordance with the counting down of the table clock by gradually changing the color of the graphical representation of the table in accordance with the counting down of the clock.

40. A software program according to claim 39, wherein said software program is operable to instruct the computer to gradually change the color of the graphical representation of a table by gradually changing the color from the top of the graphical representation of the table to the bottom of the graphical representation of the table.

41. A software program according to claim 29, wherein said software program is operable to instruct the computer to receive needs-cleaning indications, which indicate that a respective table needs cleaning and to display, on the display device of the computer in response to reception of each needs-cleaning indication, a visual indication that the respective table needs cleaning.

42. A software program according to claim 41, wherein said software program is operable to instruct the computer to display the visual indication that the respective table needs cleaning by changing the color of the graphical representation of the respective table to a color that, according to a predetermined legend, indicates that the respective table needs cleaning.

43. A software program according to claim 42, wherein said software program is operable to instruct the computer to display the indication that the respective table needs cleaning by changing the color of the graphical representation of the respective table to yellow.

44. A software program according to claim 29, wherein said software program is operable to instruct the computer to store statistical information related to the table, and to display the statistical information on the display device of the computer in response to a request for display of the statistical information input the computer by a user.

45. A software program according to claim 44, wherein the statistical information comprises table number, seating capacity, smoking preference, and duration of current seating status.

46. A software program according to claim 29, wherein said software program is operable to instruct the computer to send information to one or more mobile receivers to be used by server-persons assigned to the tables.

47. A software program according to claim 29, wherein said software program is operable to instruct the computer to receive an order-ready indication which indicates that an order made to a preparation area is ready.

48. A software program according to claim 29, wherein said software program is operable to instruct the computer to store a pre-programmed set of server configurations, each server configuration providing an assignment of tables to servers such that the tables are divided among a number of servers and providing a corresponding transmitter/receiver association data indicating which of a plurality of table transmitters is associated with each of a plurality of mobile receivers according to the assignment of table to servers of the respective server configuration, and to apply one of the server configurations in accordance with a configuration choice input to the computer by a user.

49. A software program according to claim 48, wherein each of the server configurations of the pre-programmed set of server configurations provides an assignment of some or all of the plurality of tables among a different number of servers, such that a change in the server configuration by the user changes the number of servers among which assignment of the tables is divided.

50. A software program according to claim 48, wherein said software program is operable to instruct the computer to:
display a plurality of server-number buttons, each indicating a different number of servers;
store button/configuration correspondence data indicating a correspondence between each server-number button and a respective server configuration, wherein the server-number buttons indicate the number of servers among which the assignment of tables is divided in the server configuration corresponding to the server-number buttons, respectively;
receive the configuration choice by detecting a user's touch of one of the server-number buttons; and
apply the server configuration corresponding to the server-number button touched by the user according to the stored button/configuration correspondence data.

51. A software program according to claim 48, wherein said software program is operable to instruct the computer to set a one-time temporary transmitter/receiver association between one or more of the table transmitters and one of the mobile receivers, wherein the one-time temporary transmitter/receiver association lasts through one seating cycle of the table or tables corresponding to the one or more table transmitters included in the one-time association, or through the end of a current seating cycle of the table or tables corresponding to the one or more table transmitters included in the one-time association.
